(19) United States
(12) Patent Application Publication
(10) Pub. No.: US 2013/0226601 A1
(43) Pub. Date: Aug. 29, 2013

(54) REMOTE CLINICAL CARE SYSTEM

(71) Applicants: Ronald M. Razmi, San Francisco, CA (US); Kelvin Hubbard, San Francisco, CA (US)

(72) Inventors: Ronald M. Razmi, San Francisco, CA (US); Kelvin Hubbard, San Francisco, CA (US)

(73) Assignee: Acupera, Inc., San Francisco, CA (US)

(21) Appl. No.: 13/594,667

(22) Filed: Aug. 24, 2012

Related U.S. Application Data
(60) Provisional application No. 61/526,954, filed on Aug. 24, 2011.

(51) Int. Cl. G06F 19/00

(52) U.S. Cl. CPC G06F 19/345
USPC 705/2

(57) ABSTRACT

An automated system and method provides real time disease-specific guidance to both providers and patients to enable accurate diagnosis and treatment. Content based on knowledge of specific diseases and patient history is used to determine most likely diagnoses remotely. This system uses information provided by a patient's medical records (EHR/EMR), remote monitoring devices, results of laboratory tests, diagnostic tests, and other available information.

### CROSS-REFERENCE

This application claims the benefit of U.S. Provisional Application No. 61/526,954, filed Aug. 24, 2011, which is incorporated herein by reference in its entirety.

### BACKGROUND OF THE INVENTION

1. Field of the Invention

The present invention relates generally to methods and systems for the automated determination of a probable diagnosis for a patient.

In spite of an increasing number of systems that try to connect health professionals with patients for remote delivery of care, the prior art fails to recognize the inherent shortcomings of an interaction that does not allow for close, physical examination of the patient. This lack of personal contact may lead to under- or misdiagnosis of the patient's issues.

There is a need for improving remote patient diagnosis and treatment that through the development of a system utilizing current technologies (Internet driven, web 2.0, rules engine, and relational database) between a provider and a patient. Therefore, as there are multiple systems in use or under development for providing remote medical care, the need to ensure the correct diagnosis and treatment has never been greater. The risk with a remote interaction is that physicians will have a limited ability to collect all of the information they need from the patient (or their caregiver). This can result in miss- or under-diagnosis of the patient's problems. While the system does not aim to replace a medical provider's expert judgment, it provides proprietary pathways (leveraging both the user's and the provider's technology, in a browser agnostic design) to arrive at needed information.

It is clear that remote diagnosis and management of patients (enabled through technology) will be a cornerstone of the future of healthcare. This type of interaction will allow for more convenient, lower cost, and less frequent, documented visits with a provider which will result in better monitoring and management of chronic conditions. It also will allow a high percentage of low acuity urgent clinical conditions and follow up visits to be conducted remotely, either online at home, in a kiosk, or from a mobile device. Most providers are not formally trained in providing this type of care. Clinical training for almost all providers involves communications with the patient and examinations. Although communication will be possible using audio, video, and other forms of technology enabled interactions, the nature of this communication will be more limited than in-person visits. Also, although certain data can be acquired using remote monitoring devices or visual inspection using web cameras, many of the critical pieces of information will not be readily apparent or available. Also, only a minority of patients will have remote monitoring devices used in their care. The present invention is meant to help providers and patients to collaborate in getting at these critical pieces of information.

2. Background Art

Brown, US Patent Applications 20060004611 and 20070061167 respectively filed on Jan. 5, 2006, and Mar. 15, 2007, and reported a system to capture data from a remote apparatus seeking answers from patient to some questions posed by a remote medical professional to determine health condition and remotely instructing the patient on the management of the conditions through programmable scripts.

Benigno et al., U.S. Pat. No. 6,230,142, issued on May 8, 2001, reported a system to analyze captured data to determine to clinical decisions based on the analysis of a hospitalized patient to discharge and to determine post-discharge clinical pathways.

### SUMMARY OF THE INVENTION

The system of the present invention is designed to use a multitude of resources including patient's symptoms, past medical history, third party data, etc. to match both the patient and the provider with proprietary content that enhances the quality of their interaction. The intelligent design of the system also allows the provider to activate alternative content and pathways based on real time information collected from the patient. Also, the System identifies certain key missing elements from the ongoing treatment plan of the patient at the conclusion of the interaction based on the final activated content and pathway (based on the diagnosis) and alert the provider to additional steps that can be taken to improve the treatment plan of the patient and the long-term outcomes.

The methods utilize an interface and a processor for determining a probable diagnosis from a number of possible diagnoses based both on the patient's presenting symptoms, and on the patient's pre-existing diagnoses. A matrix of possible diagnoses and presenting symptoms is provided where each presenting symptom has an assigned probability value for each possible diagnosis. The n-tiered nature of the architecture allows this matrix to be constructed by coordinating information from the database layer (such as EMR records from a patient medical history module in the database layer) with relevant presented symptom information collected in the presentation layer.) A list of pre-existing diagnoses for the particular patient being diagnosed may also be provided to the medical provider if a live remote consultation is being provided. The processor generates a patient-adjusted matrix of possible diagnoses and presenting symptoms having patient-adjusted probability values which are determined based upon the patient's pre-existing conditions and other risk factors (smoker status, BMI, age . . . ). The patient or someone acting on the patient's behalf then answers one or more questions to determine if the patient has a particular presenting symptom and other related symptoms. The patient-adjusted probability value for each possible diagnosis is then determined based upon the presence or absence of the symptoms as determined in the prior step. An accumulated patient-adjusted probability value is then calculated for each possible diagnosis by adding the values determined in prior iterations. While it may be possible in some instances to determine a probable diagnosis based on only a single question, usually it will require a series of two, three, four, five, or more sequential questions and answers in order for any possible diagnosis to accumulate a patient-adjusted probability over a pre-determined threshold value which is sufficient to indicate that the possible diagnosis is a probable diagnosis. Once one of the possible diagnoses accumulates a patient-adjusted probability value exceeding this predetermined diagnostic threshold value, then the patient will be assigned a probable diagnosis. Most often, only a single probable diagnosis will be assigned, but it may be possible in unusual circumstances that two or more probable diagnoses will be assigned if the accumulated patient-adjusted probability values have been exceeded for their associated diagnostic threshold values at the same time. In cases where no accumulated patient-adjusted probability values determined in the calculating step exceed the associated pre-determined threshold value, then additional question(s) will be asked in order to determine the presence or absence of additional symptoms.

In specific aspects of the method of the present invention, the interface may be selected from any one of a variety of typical user interfaces, including tablets, kiosks, computers, smart phones, telephones (where the information may be input verbally), and the like. The processors utilized in the methods of the present invention may also comprise typical digital processors, including central processors, groups of distributed processors, where parts or all of the processing may be done on remote facilities (in the “cloud”). In all cases, the interface and the processor will typically be networked, either in wired networks, wireless networks, or combinations of wired and wireless networks. In other cases, it may be possible for the interface and at least a portion of the processor to be located in an integral unit. In such cases, at least one of the matrix of possible conditions and presenting symptoms and the list of patient pre-existing conditions will be maintained at a remote location accessible via a network or the internet. In order to increase the efficiency of the automated diagnosis, the order of questions asked will typically be prioritized in order to increase the likelihood that questions which are most relevant to the patient condition will be asked earlier rather than later. This way, the total number of questions needed before a possible diagnosis has an accumulated patient-adjusted probability value above the predetermined diagnostic threshold value may be reduced. The order of questions may be prioritized based on the patient's pre-existing conditions and risk factors. That is, questions which are highly determinative or diagnostic of one of the pre-existing conditions may be asked earlier rather than later. Alternatively or additionally, the order of questions asked may be prioritized based upon the increasing or decreasing accumulated probability values for each condition determined after one or more questions have been asked and the accumulated patient-adjusted probability values determined for each of a plurality of possible diagnoses. In such cases, for example, questions relating to a presenting symptom characteristic of a possible diagnosis which has an accumulated patient-adjusted probability value which is increasing relative to the accumulated value for other possible diagnoses may be asked earlier rather than later.

The questions asked to determine if the patient has a particular presenting symptom will typically be capable of being answered by a “Yes” or a “No”. In some instances, the questions may ask for information beyond a simple “Yes” or “No” answer. Further optionally, the method may provide for inputting presenting test data into the interface where the determination of the patient-adjusted probability value for each possible diagnosis will be based upon the test data as well as on the symptom(s) determined based on the patient's answers to the presented questions.

Once a probable diagnosis has been determined by the method, further questions may be presented and answered via the interface in order to determine the severity of the condition after the probable diagnosis has been assigned.

The methods of the present invention are useful with a wide variety of possible, pre-existing, and probable diagnoses including at least some conditions selected from the group consisting of COPD, congestive heart failure, diabetes, hypertension, asthma, depression, and the like. The methods may also rely on a wide variety of presenting symptoms including the most deterministic symptom from each of the potential diagnoses. The optional test data utilized in the methods of the present invention may include at least some data selected from blood pressure, heart rate, temperature, glucose level, weight, and the like. The most useful test data may include data which the patient may acquire using patient-administered tests or equipment, which may be automatically uploaded to their access device, or manually entered.

Systems according to the present invention for determining a probable diagnosis for a patient comprise databases, a processor, and an interface. At least a first database is provided with a matrix of conditional probability values for each of a plurality of possible diagnoses based upon each of a multiplicity of symptoms. A second database provides a list of pre-existing diagnoses and risk factors for the individual patient being diagnosed.

The processor communicates with the interface and receives data from the matrix database and the list database. The processor is configured to perform a number of steps or manipulations of the data from the databases. A patient-adjusted matrix of patient-adjusted probability values is generated by adjusting the probability value matrix from the database based upon the patient's pre-existing conditions and risk factors. Typically, the probability value for possible diagnoses which are the same as pre-existing diagnoses and risk factors where the patient will be given a higher probability value than those values associated with conditions and risk factors not associated with the patient. The processor then generates and presents question(s) on the interface, where answer(s) input on the interface determine if the patient has a presenting symptom. The processor further determines the patient-adjusted probability value for each possible diagnosis based upon the presence or absence of the presenting symptom and additional symptoms and readings using the patient-adjusted matrix of patient-adjusted probability values. For the presence or absence of each patient symptom or reading which is determined, an accumulated patient-adjusted probability value is calculated for each possible diagnosis. Initially, the accumulated value will be the value for each possible diagnosis based on the first presenting symptom which is assessed. As additional symptoms or readings are assessed, the incremental patient-adjusted probability values may be added and accumulated so that the values will increase, with the probable diagnosis values increasing more rapidly. It should be noted, in some instances, the presence or absence of a patient symptom will result in a subtraction from the accumulated patient-adjusted probability value associated with a particular possible diagnosis.

After the presence or absence of a sufficient number of symptoms and readings has been determined, an accumulated patient-adjusted probability value will exceed a predetermined diagnostic threshold value, making the associated possible diagnosis the probable diagnosis. Until at least one of the accumulated probability values for one of the possible diagnoses exceeds the associated diagnostic threshold value, the system will continue to determine the presence or absence of additional symptoms or readings.

The system may have a wide variety of hardware implementations. The interface may be any input/output device with an approved browser, enabling the patient or other human user to input data to the processor. Exemplary interfaces include tablets, kiosks, computers, smart phones, telephones, and the like. Similarly, the processor may comprise any digital data processing system, including central processors, distributed processors, and the like. Typically, the interface, processor, and other elements of the system may be networked from remote locations, and some or all of the networking may be provided by the internet. In some instances, the interface and at least a portion of the digital processing capability of the processor may be located in an integral unit. Typically, at least one of the matrix of possible diagnoses and the list of patient pre-existing conditions will be maintained at a remote location.

The processors of the systems of the present invention will often be further configured to prioritize the order of the questions being asked. The order may be prioritized on any available basis, including the existence or absence of the patient's pre-existing conditions and risk factors, and upon the probability values which are being iteratively determined for each possible diagnosis as additional questions are asked and answered.

The processor may be further configured to allow for inputting presenting test data through the interface so that the test data may be relied on as well as the presenting symptoms and additional symptoms in order to determine the patient-adjusted probability value for each possible diagnosis.

The processor may be still further configured to ask additional questions and consider further answers which allow determination of the severity (stage) of a condition after a probable diagnosis has been assigned.

In a typical embodiment the system is also configured to accept real time data from periphery medical devices on either the user or provider end. For instance a diabetic patient using the remote clinical care system can connect a blood glucose meter to his or her home computer to incorporate real time blood glucose measurements into his or her diagnostic data. This ability is particularly useful for medical care providers monitoring a patient's chronic condition. Such third party devices may include but are not limited to, heart rate monitors, blood pressure monitors and hardware of the like.

In typical embodiments of the invention the system can actively track symptoms related to chronic conditions. For example a patient with COPD could regularly report the status of his or her symptoms. The system can track symptoms over a period of time and assess the current treatment efficacy. If the symptoms worsen a healthcare provider can be automatically notified and the treatment plan may be revised. The present invention can offer suggestions on treatment plan revisions by activating various treatment modules from the expert content. These treatment modules may combine the input of medical experts to produce a clear concise summary of the latest knowledge in the field regarding the treatment in question.

In a typical embodiment of the present invention, the system guides the provider and the patient through a series of screens that mix information gathering, guiding (pattern matching algorithms, search engines, and relationally structured data), alerts, etc. to arrive at the best possible outcomes. This content is specific to the patient complaint and history.

The system software typically uses a rules based engine designed in the Service-Oriented Architecture “SOA” layer using web services designed to identify which content is appropriate for that particular interaction, and delivers it using an n-tiered web architecture. Although described below in terms of the SOA and web architecture, the present invention can be implemented using current and after developed computer technologies as can be appreciated by one of ordinary skill in the art. For example, if a patient logs into the system with a complaint of shortness of breath and has a history of heart failure, as determined through a series of questions delivered via the web application, the Heart Failure Remote Care Pathway is initiated. This Pathway is customized to collect key pieces of information that a provider needs to know to determine if the patient is having an acute episode of heart failure. Additional pathways providing a variety of specialties may be provided.

Guidance through the system is accomplished using the rules engine. The rules engine may guide both the provider and patient through exercises (supplemented by visual cues delivered via the network such as the internet, in a secure SSL implementation) that aim to uncover clues as to whether the patient has certain diagnostic symptoms. For example, in a heart condition analysis, the rules engine may request information to determine whether the patient has fluid retention and increasing weakness of the heart.

The rules engine may compare the patient's current treatment with the received diagnostic information to determine deficiencies and care gaps. For example, the rules engine may compare the patient's treatment for heart failure with recommended guidelines. This comparison may be accomplished using the rules engine, which may run an algorithm of pattern matching with known treatments and protocols. Once a determination is made, the rules engine may send out an instruction to notify the physician and/or modify the patient's current treatment. For example, if a patient with NYHA Class II heart failure is not treated with beta blockers but guidelines and experts see that as a critical piece of treatment to achieve the best possible outcomes, the system can generate a reminder notice for the provider. Such notice can be in the form of a pop-up window or other notification technology. The physician may determine that beta blocker treatment can improve the patient's heart failure program or decide that due to the patient's asthma (contained in their EMR record, stored in the database, or retrieved from an Electronic Medical Record “EMR” partner), beta blockers may not be the right choice in this case. The end result of this is the improved quality of the video, audio, or chat interaction between a provider and the patient.

According to one embodiment of the invention, the system utilizes physician-directed, patient-performed examination that utilizes innovative approaches to allow for the most effective treatment possible. The examinations may be recorded and the determinations made during examinations may be reported to the physician and/or the system to make determinations of the patient's underlying conditions. The remote interactions, using the system, will have a higher chance of success as a result of this proprietary knowledge base, and the short-term and long-term outcomes will be improved. This will result in higher efficiency and lower chance of follow up visits to a medical facility. This will also result in a lower overall cost of care as chances of correct diagnosis and treatment with the initial visit is improved, and the need for institutional care is lowered.

It is an objective of the present invention to provide a system that will improve the quality of the remote interactions between healthcare providers and patients. As remote healthcare delivery becomes more common and an accepted way to seek care, it is important to understand its limitations and create innovative approaches to bring its quality and outcomes as close to an in-person provider visit as possible. This is accomplished in this invention by combining one or more of the following expert knowledge, patient entered information, physician expertise and judgment, and technology (rules engine, relational database, and rich internet content) to create the best possible scenario in which accurate and timely diagnosis can be achieved. Remote visits are meant to prevent unnecessary provider visits, ER and hospital visits and shift care to a lower cost setting. Patients will have variable abilities to provide information that can enable the provider to arrive at the correct diagnosis and treatment plan. Accordingly, an unproductive remote visit with a provider may paradoxically lead to an ER visit or hospitalization. The system was designed with the goal of recognizing these limitations and using proprietary content generated by experts, combined with technology that takes data from the patient, EMR/Electronic Health Records “EHR,” laboratory tests, diagnostic examination, remote monitoring devices, and third party systems, and matches them to achieve the best possible clinical outcome.

The system is a combination of content, expertise, and technology. The physical examination of a patient often provides critical clues to the diagnosis of the active patient problems, and along with history, laboratory findings, and diagnostic testing is a critical component of a medical interaction. Some of the key elements of this component are missing in a remote interaction, even if video conferencing allows the provider to see the patient and visually inspect certain body parts. This can lead to under- or miss-diagnosis of certain medical conditions. This creates the risk for worse clinical outcomes and possibly protracted and costly care.

In one embodiment of the invention, the system uses proprietary, disease-specific content that has been generated by world class specialists to assist the providers and patients to arrive at most of that missing information through innovative approaches and maneuvers, supervised or viewed by the provider or other health care professional. This content includes care pathways, a rules engine, and alternative methods of determining answers to key pieces of data that physicians usually determine through physical examination. The advantage of this content is to create a high baseline for physician competence in managing simple or complex medical issues remotely. This content is developed with the foresight that there are a few key questions and issues that the provider is trying to solve to arrive at the right diagnosis. These questions, along with the patient answers are then combined in the rules engine to drive additional questions, and content. The nature of a remote interaction will alter how history is obtained, and limits the availability of physical exam information. Accordingly, it will take some time for physicians to develop the right expertise to succeed in this setting. The system content will immediately enhance provider skills and comfort in approaching many of the medical diagnoses that may be challenging to approach remotely.

In a typical embodiment of the present invention, the system aims to identify gaps in the treatment plan for the active problem or additional diagnoses that may be an issue for the patients at the time of their visit. Although decision support tools and guideline-based systems exist to help physicians practice evidence-based medicine, the system uses not only guidelines, but the latest developments in the field that have not yet been incorporated into the guidelines to provide the most updated tool to identify gaps in care, and offer alternative, more convenient approaches to the patient's key medical diagnoses. This includes guidance for patients on how best to comply with medical treatments and alternative approaches to improve their symptoms and long-term health, as well as remote and mobile applications to allow patients to record and follow their ongoing treatment and progress. Using the system, and the underlying technology of the system, the patient will have a clear understanding of how each component of the treatment can affect their health, and how a gap could alter their ability to achieve the optimal outcome.

According to one embodiment of the invention, the system may include software modules that perform certain functionality. For example, the system may include one or more databases that store relevant patient and disease information such as the patient's entered information, past medical history, laboratory and diagnostic data, and data from remote monitoring devices. The system may further include an intelligent rules engine that can use a SOA or Enterprise Service Bus “ESB” middleware component that can use the information stored in the databases to activate the right content and pathways for parties involved in the patient/provider interaction. This has the advantage of providing real-time content that is relevant and meant to ensure the best possible outcome.

The system may be designed to dynamically update the patient specific database content based on the progress of the interaction and additional information gained from the patient's “visit.” The System may increase the speed and efficiency of a patient/physician remote visit by providing visual screens that allow an easy way to capture the relevant information. During the remote visit, relevant information may be displayed on the screens, such as information related to diagnostic and treatment plans, medical libraries, follow up visits, specialist referrals, remote consults, and other related tasks. The information to be displayed may be determined by the rules engine. For example the rules engine can match guidelines and best practices for a particular diagnosis with the patient's treatment plan, and identify any gaps in the patient's current treatment. The rules engine's determination may be done by using pattern matching and a proprietary search algorithm to achieve the best possible clinical outcomes. The rules engine may determine and prompt the system to display information related to therapies that the patient should be on, or therapies that the patient is following and should be avoided. This intelligent technology creates alerts for the provider that they can review, and decide if it makes sense for the patient. If there is a clinical reason that the recommendations do not make sense for the patient, the physician can override them. The final instructions that the patient receives are determined by the physician and can be customized based on the tools contained in the System.

As described above in the descriptions of exemplary embodiment and aspects of the present invention; the invention utilizes an n-tiered computing architecture. The n-tiered computing architecture comprises layers that may include but are not limited to a presentation layer, application layer, a SOA (Enterprise Service Bus) layer and a database layer. The purpose of these layers and their design is to accomplish the coordination and harvesting of information contained within or obtained from the various layers. The presentation layer, typically web based, facilitates interactions between the patient and provider and various aspects of the other layers. Processors employing logic engines facilitate the coordination and communication of information between layers (for the purposes of describing the invention the term processors and logic engines may be used interchangeably). In exemplary embodiment of the inventions an n-tiered architecture facilitates the coordination of the user interfaces with an ever expanding list of functional programming modules and database resources to facilitate diagnosis and treatment planning for patients and medical care providers.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows a diagram showing a flow chart describing the process from the time the patient or provider logs into the system with activation of the content to the interaction with other parties, identification of gaps in care and creation of the record of the interaction and care and follow up instructions

FIG. 2 shows an example of an overall architecture of the application environment, which can include all of the applications included in the total solution, the interaction with the SOA/ESB layer, and the connections with the underlying database layer.

FIG. 3 shows a drawing that highlights embodiments of the system, as it fits into the overall architecture. This drawing shows how each layer of the architecture is connected with the other layers, and indicates some of the specific technologies used in the Presentation layer.

FIG. 4 shows computer screens that the patients see upon logging into the system, offering options to visit with a provider, schedule appointments, seek a referral, join online communities, etc.

FIG. 5 shows computer screen showing an initial screen collecting basic information from the patient. Reason for visit and past medical history are the initial basis of activation of appropriate content and follow up questions.

FIG. 6 shows computer screen showing dynamic content that is activated based on responses to the initial questions and collects the appropriate information from the patient.

FIG. 7 shows computer screen showing system-assisted, coordinator guided, patient performed physical examination with appropriate process to capture the information for the physician.

FIG. 8 shows computer screen showing the initial screen for the physician with appropriate and relevant data presented to make the interaction as efficient as possible.

FIG. 9 shows computer screen showing the physician probing the relevant collected data by the System with the patient to gain better understanding of the patient issues.

FIG. 10 shows computer screen showing the patient probing data collected by the system assisted, care coordinator guided, and patient self-performed examination.

FIG. 11 shows computer screen showing physician treatment plan after visiting history, examination, laboratory, and diagnostic data.

FIG. 12 shows computer screen showing a global check system for checking current patient treatment against guidelines and expert developed best practices and identifying areas for improvement of care.

FIG. 13 shows discharged instructions customized to patient's diagnosis and aimed at achieving best long-term outcomes.

FIG. 14 shows a login screen with a patient profile and brief medical history

FIG. 15 shows one page of a series used to input presenting symptoms

FIG. 16 shows a child question following in the input of a “shortness of breath” symptom

FIG. 17 shows another screen generated by the system to acquire patient symptom information

FIG. 18 shows a provider interaction page with the patient's medical information and the option to create a diagnosis/treatment plan.

FIG. 19 shows a diagnosis/treatment plan page.

FIG. 20 shows a probability matrix generated by the processor/logic engine for determining the most probable diagnosis for a given set of symptoms and patient medical history.

FIG. 21 shows a probability matrix similar to that of FIG. 20 with the additional feature of symptom and condition staging

FIG. 22 shows a flow diagram of the logic engine use to determine a most probable diagnosis for the patient

FIG. 23 shows a flow diagram for the patient interaction with the remote care system.

FIG. 24 shows different logics by which the system chooses the next question to ask the patient in order to deterring the most probable diagnosis.

FIG. 25 shows a flow diagram of the patient interaction with the remote care system including probability score calculations.

FIG. 26 shows a flow diagram of the procedure to generate a treatment plan for the patient.

### DETAILED DESCRIPTION OF THE INVENTION

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The phrases such as “in one embodiment” or “in certain embodiments” in various places in the description are not necessarily, but can be, referring to the same embodiment. Use of the term “preferred” or “preferably” is intended to indicate a configuration, set-up, feature, process, or alternative that may be perceived by the inventor(s) hereof, as of the filing date, to constitute the best, or at least a better, alternative to other such configurations, set-ups, features, processes, or alternatives, based on certain, but not all criteria. In no way shall the use of the term “preferred” or “preferably” be deemed to limit the invention to any particular configuration, set-up, feature, process, or alternative.

As such, those skilled in the art will appreciate that the conception, upon which this disclosure is based, may readily be utilized as a basis for the designing of other structures, methods and systems for carrying out the several purposes of the present invention. It is important, therefore, that the invention be regarded as including equivalent constructions to those described herein insofar as they do not depart from the spirit and scope of the present invention.

For example, the specific sequence of the described process may be altered so that certain processes are conducted in parallel or independent, with other processes, to the extent that the processes are not dependent upon each other. Thus, the specific order of steps described herein is not to be considered implying a specific sequence of steps to perform the process. In alternative embodiments, one or more process steps may be implemented by a user assisted process and/or manually. Other alterations or modifications of the above processes are also contemplated. For example, further insubstantial approximations of the process and/or algorithms are also considered within the scope of the processes described herein.

In addition, features illustrated or described as part of one embodiment can be used on other embodiments to yield a still further embodiment. Additionally, certain features may be interchanged with similar devices or features not mentioned yet which perform the same or similar functions. It is therefore intended that such modifications and variations are included within the totality of the present invention.

The present invention relates to methods and systems for providing relevant content during a remote clinical visit. For example, the invention provides computer implemented methods and systems that can determine the relevant information for display during the diagnosis of a specific condition. Furthermore, the invention provides computer implemented methods and computer systems for determining whether a prescribed treatment or diagnostic conforms with a best practices method or system.

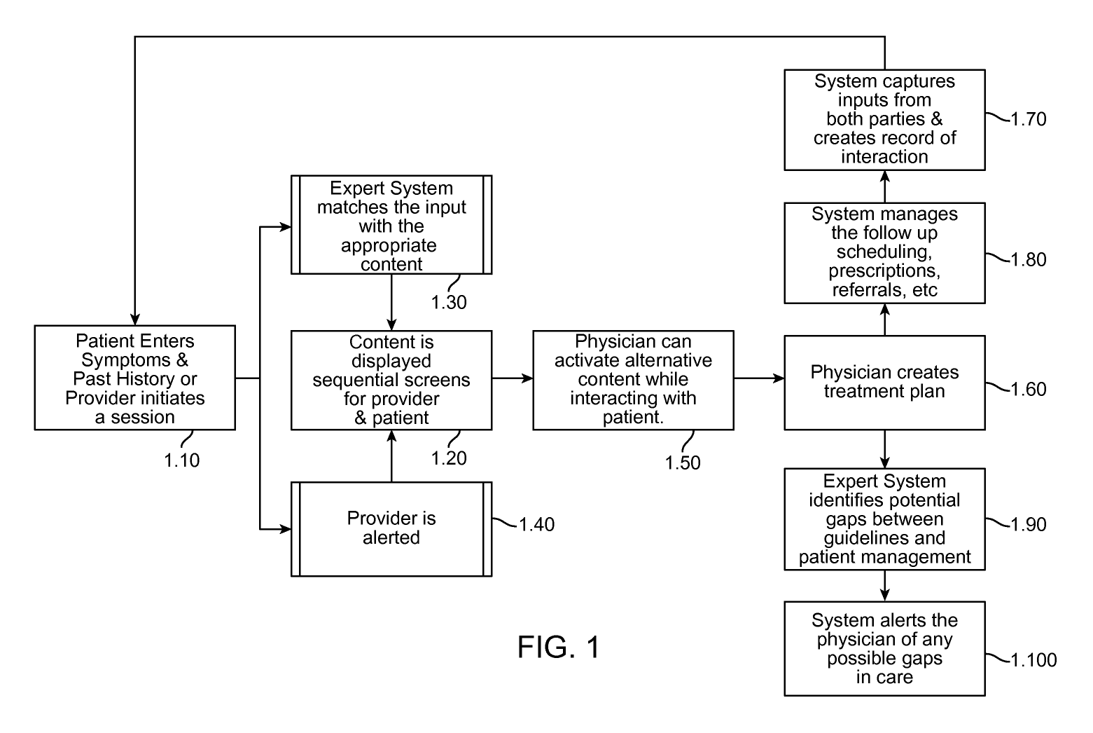

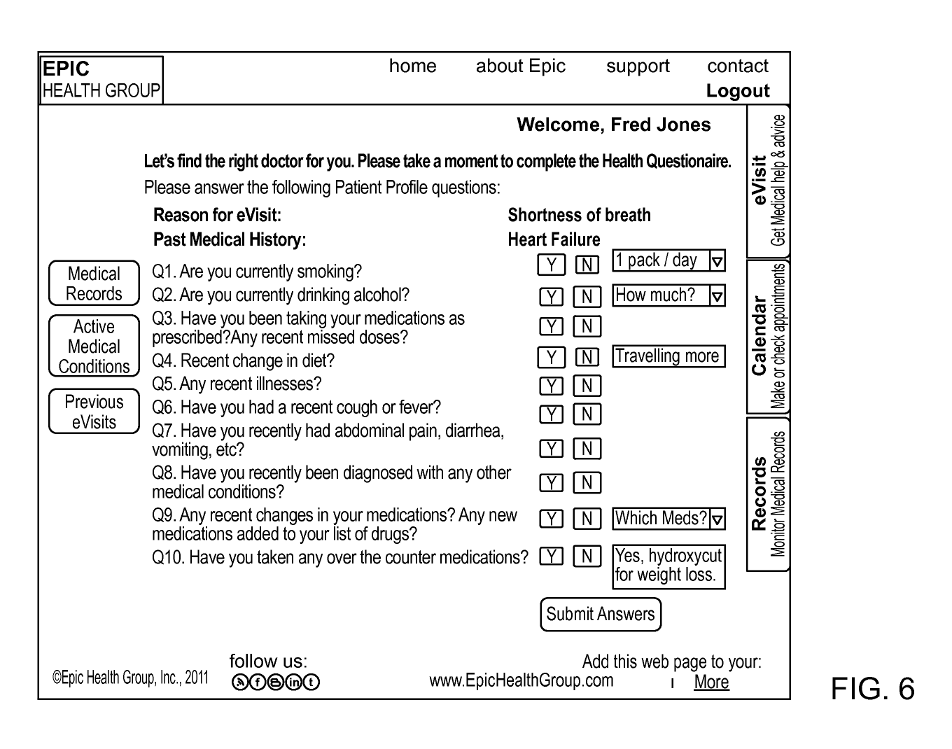

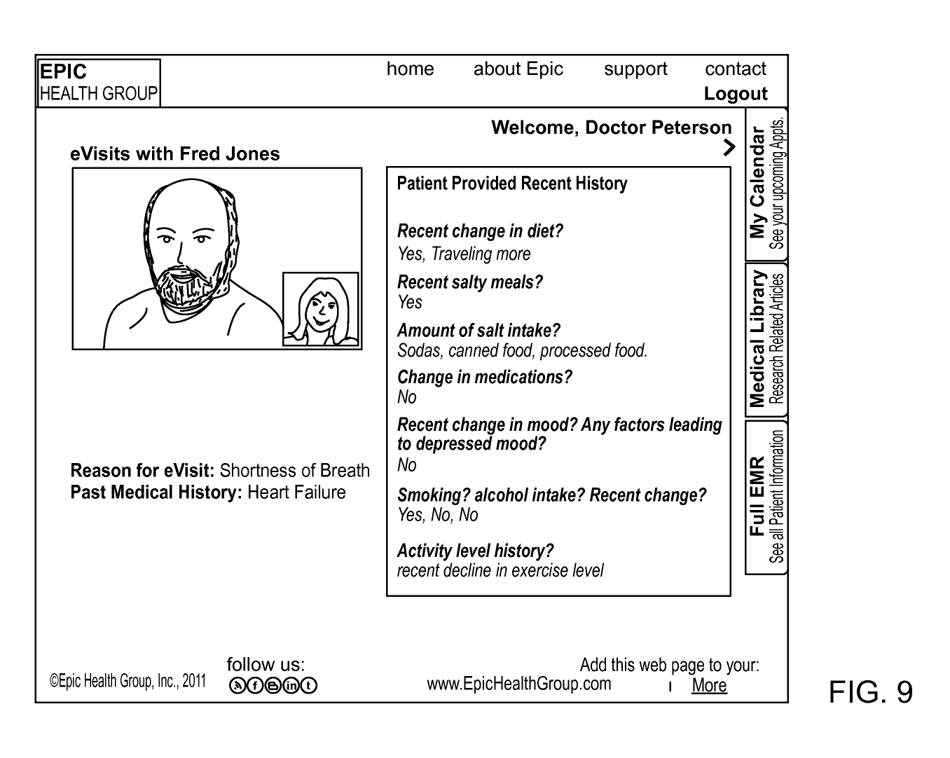

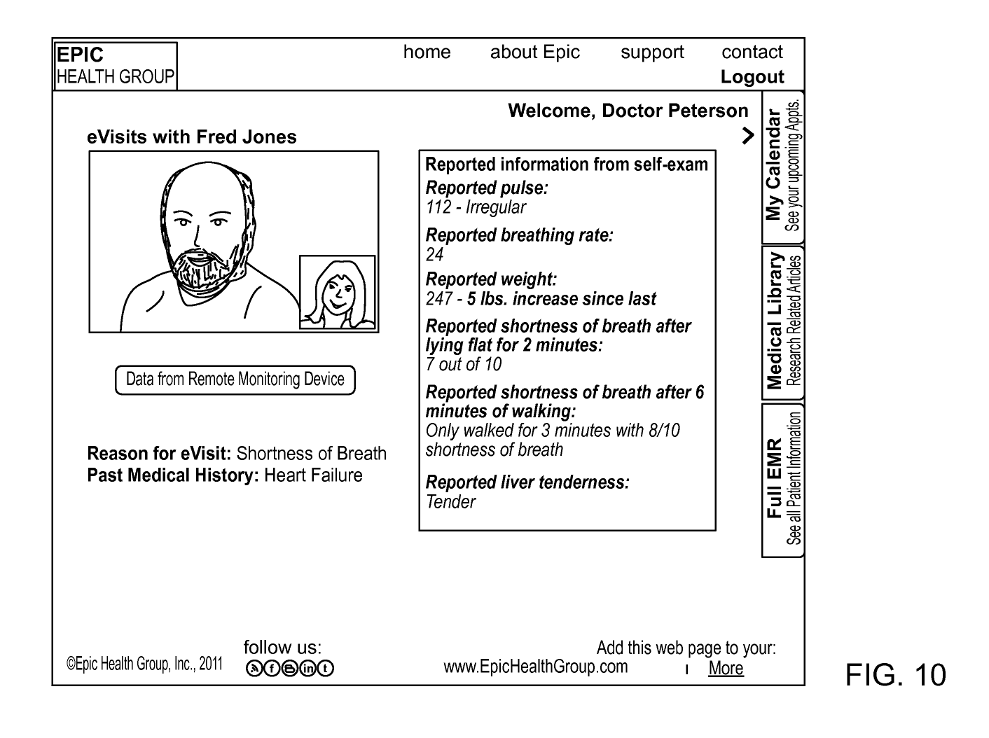

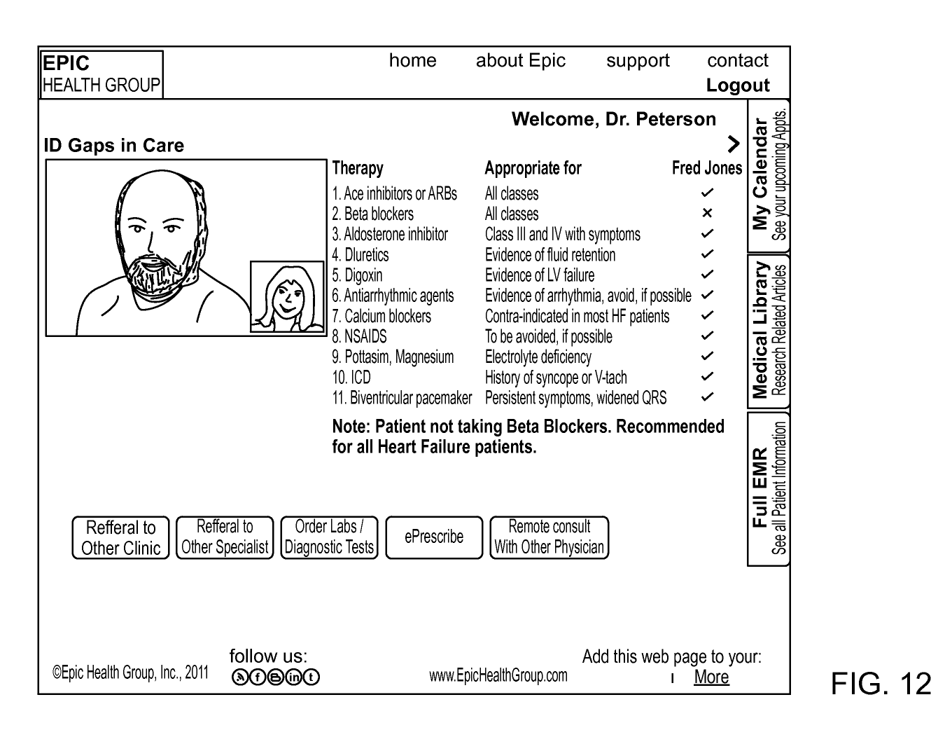

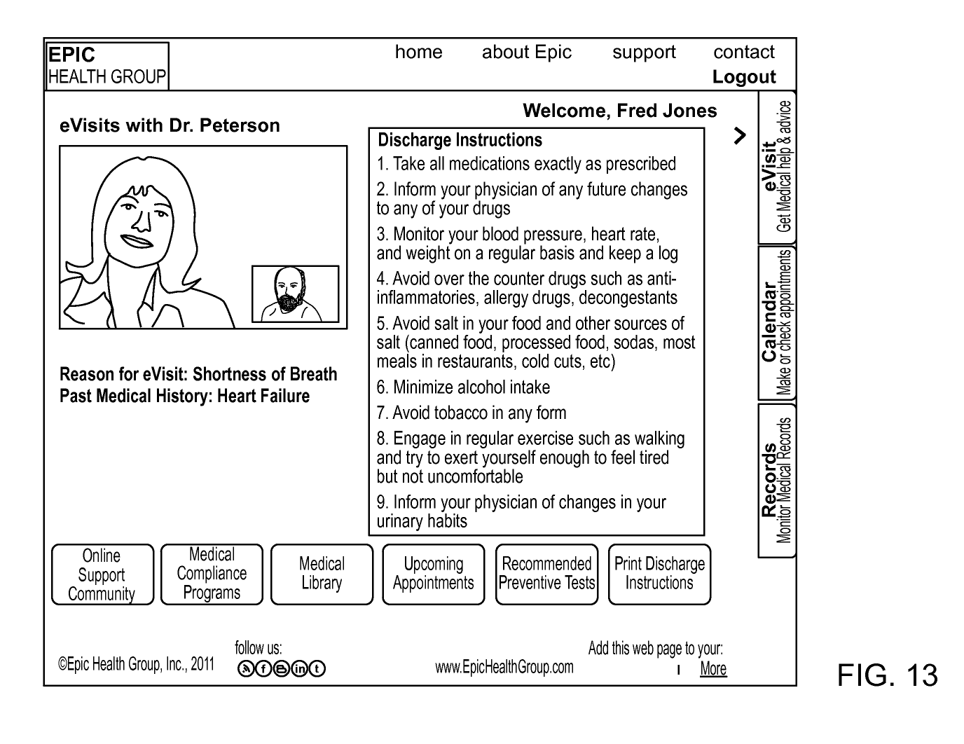

The following FIGS. 1-13 and their accompanying descriptions provide detailed examples of the implementation of the systems and methods of the present invention in accordance with one or more embodiments of the invention. It should be noted that the fields shown in the various graphical user interfaces (“GUI”) are purely exemplary and more, fewer or different types of fields can be used as a matter of design choice without deviating from the scope of the invention.

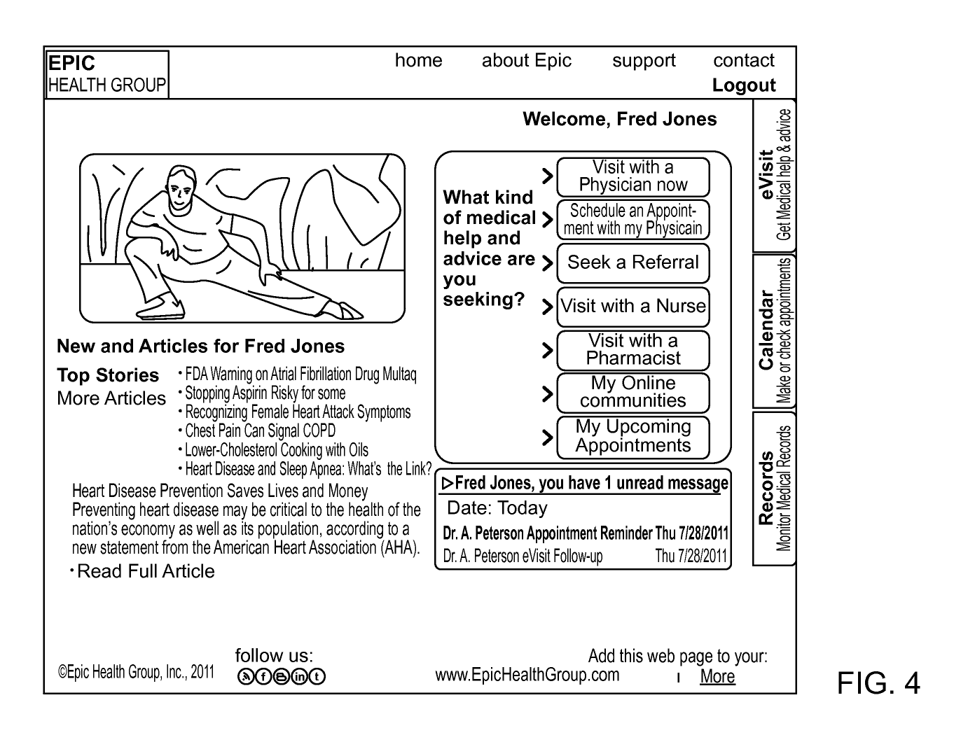

The flow of the process used by the system with reference to the flow chart of FIG. 1 and the user interfaces of FIGS. 4-13 will now be discussed. A patient or a provider can log into the system and initiate a session (FIG. 4). During the session patient may be prompted to input the reason for the visit and relevant past medical history. The System may match the received information with disparate pieces of data from the patient, medical records, current and past medications, and other sources to match the main reason for the visit with existing modules and disease care pathways to initiate the interaction (FIG. 1.30, 5). The System may also match the reason for visit with an appropriate provider (FIG. 1.40). Questions are asked/answered and device data collected before the appropriate provider is selected; this can be a physician, care coordinator, nurse, pharmacist, etc. While the provider is reviewing available information about the patient, the System may initiate the appropriate content/module to guide the patient through a series of questions and screens to identify sources of the patient's problem(s), relevant data that can be of help to the provider about that diagnosis, including current symptoms, past experience with similar issues, date of diagnosis, past diagnostic studies, medications, interventions, lifestyle factors relevant to the diagnosis, potential precipitating factors, etc (FIG. 1.20). If the provider is initiating the session, they can choose the appropriate module for the visit as they are already aware of the diagnosis.

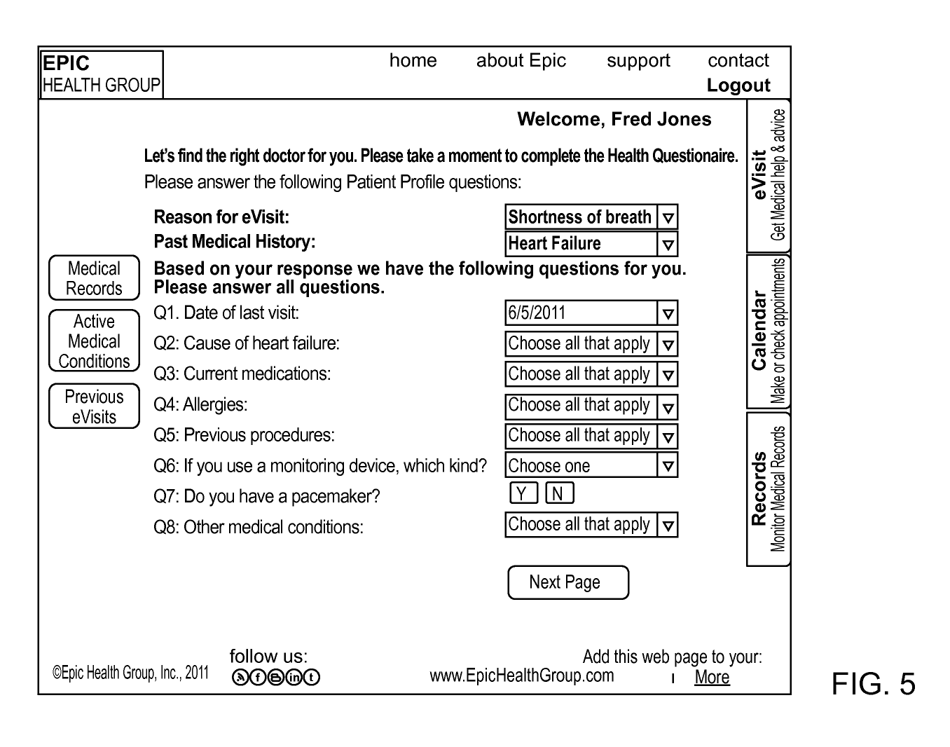

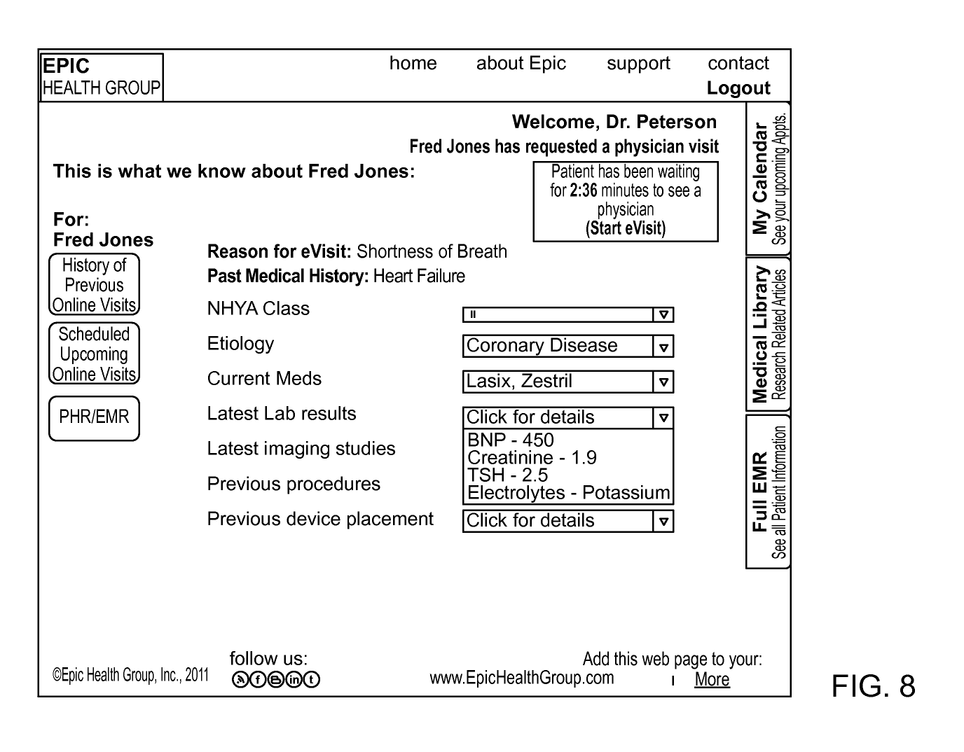

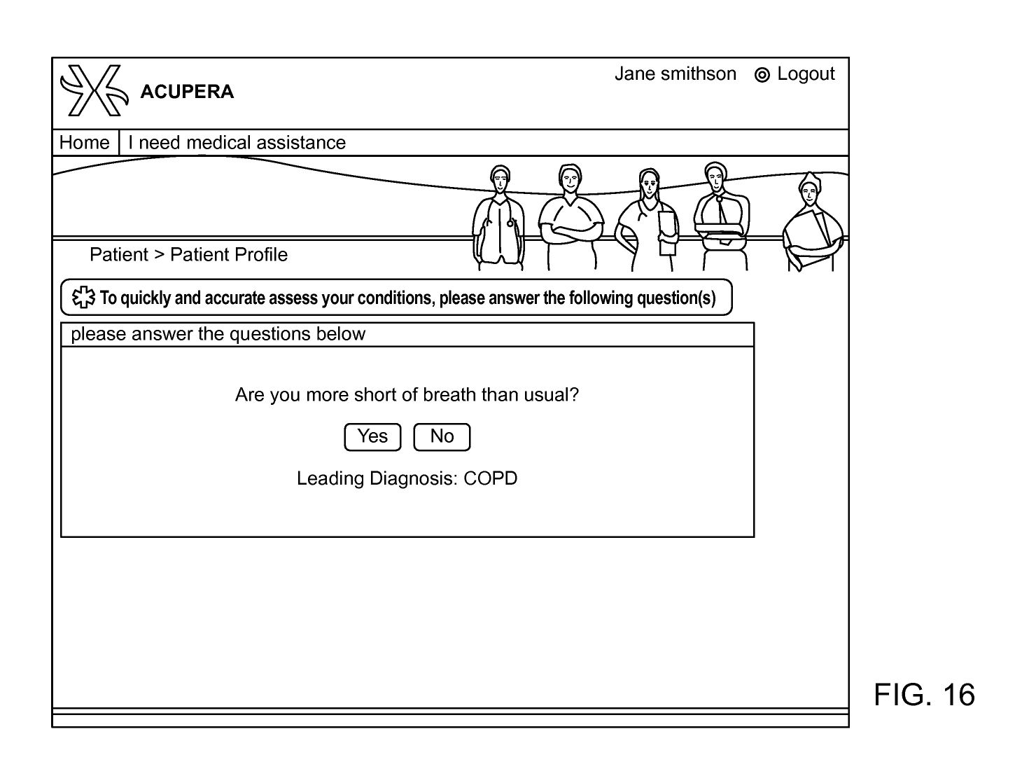

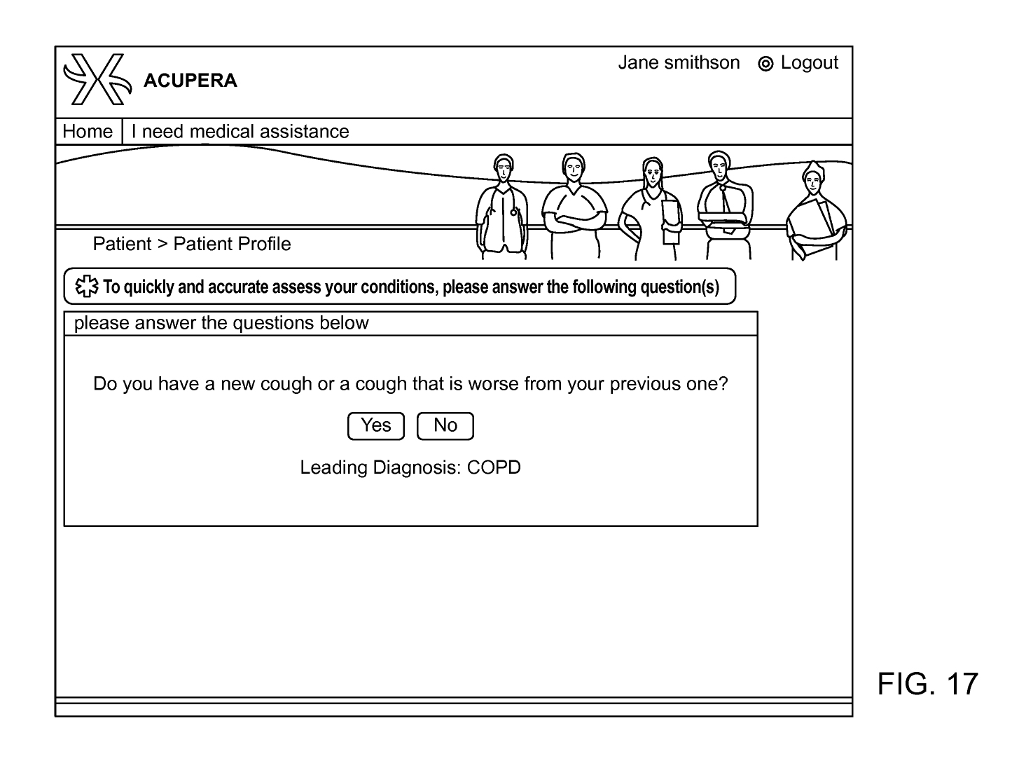

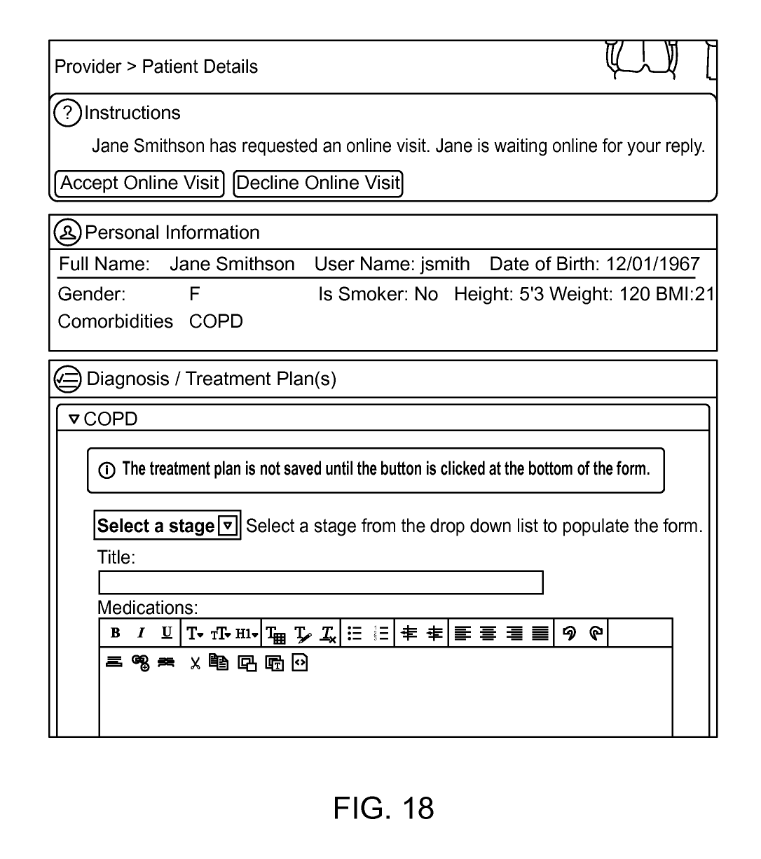

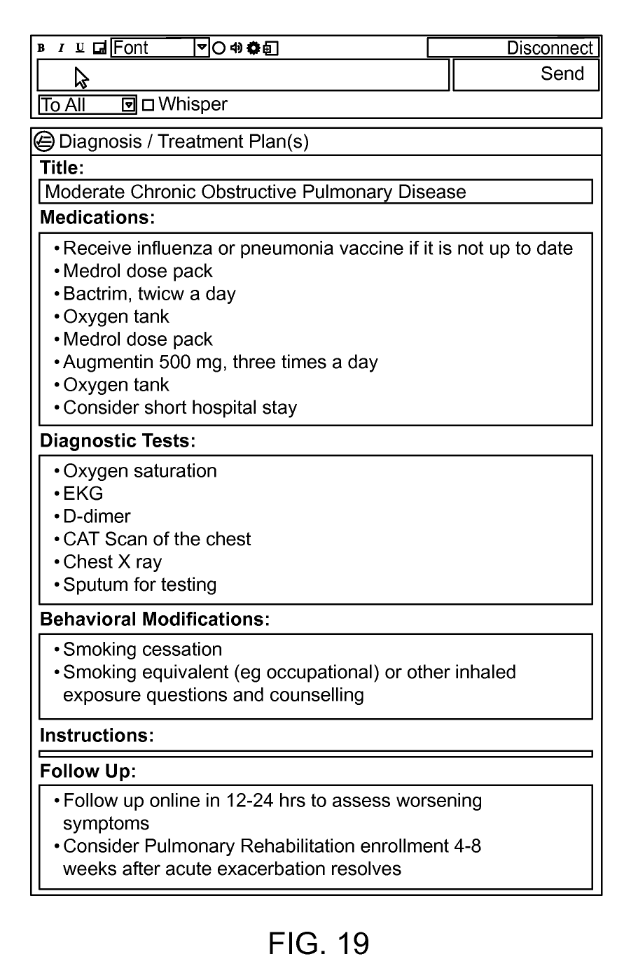

The system is meant to help guide the experience of each user based on the initial reason for the visit. The patient is guided through multiple screens (FIG. 5-7) to collect the appropriate pieces of information that a provider would need to succeed in helping the patient in their session. The nature of the information collected from the patient is meant to be highly relevant and specific to the potential causes for the patient's issues and the type of information that a provider would need to spend a long time collecting or may skip due to time constraints. A remote interaction is usually more limited in the level of interactivity than an office visit and thus may lead to the physician or the patient exchanging less information than they would otherwise. The system is designed to help overcome this limitation by prospectively collecting this information from the patient and making it available to the provider before or during their visit with the patient. (1.20, FIG. 8-10.) FIGS. 15-17 show multiple screens where the patient self-reports symptoms. The various logic engines described elsewhere herein select new questions based on previous responses and known aspects to the patient's medical history to arrive at a previous diagnosis. A probable diagnosis can then be presented to the medical provider in the remote consultation session. If no diagnosis is found the symptomatic information can then be presented to the provider. If a provider suspects a different diagnosis or cause for the patient's issues, they can activate an alternative module and care pathway and use the newly activated content to interact with the patient and continue to probe until they are comfortable with the diagnosis and treatment plan reached (1.50.) FIG. 18 shows an example of a provider interface wherein the above collected information is presented to the provider. Although not shown here, a probable diagnosis may also be displayed based on the patients answers to symptom based questions. Also shown in FIG. 18 is a diagnosis/treatment plan wherein the provider can populate forms by selecting a treatment/diagnostic care pathway module. FIG. 19 shows a completed diagnosis/treatment plan form including medications, diagnostic tests, behavioral modifications and follow up instructions. This diagnosis/treatment plan can then be modified by the provider by deleting items, adding new items, or adjusting items to meet an individual patient's needs.

Once a physician creates a treatment plan (FIG. 1.60, 11), the system may compare a final treatment plan against established guidelines and best practices in the field to identify any gaps or areas for improvement (FIG. 1.90, 12). These guidelines and best practices may be created by experts in their respective fields and may represent practices that are above the minimum requirements for treatment of a condition. The best practices guidelines and practices may provide the physician with the efficiency of providing the patient with a diagnosis that not only treats current issues but also ensures long-term health and optimal outcomes. The physician has the discretion to incorporate the system's recommendations into the treatment plan or override the system based on their clinical judgment and other patient issues that might be relevant and invalidate the recommendations. One of the features of the system is the incorporation of input from medical providers other than physicians.

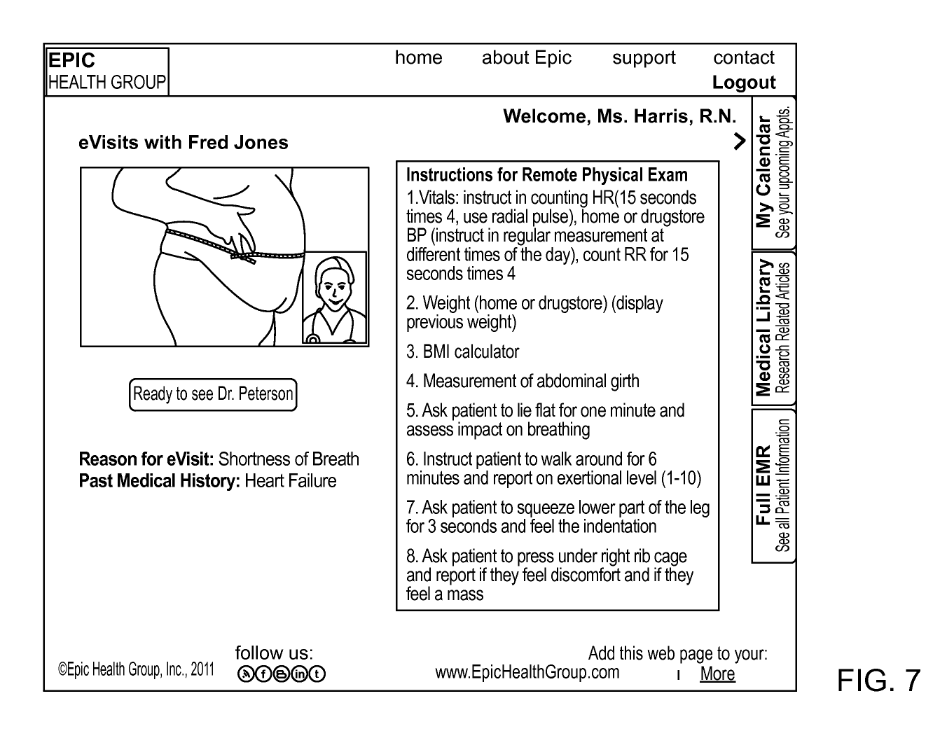

For certain parts of the visit, the system may allow a physician extender to help the patient using the provided graphical interfaces (FIG. 7). FIG. 7 illustrates a remote examination that collects physical exam information that the provider would need to determine the correct diagnosis for the patient's signs and symptoms. The care coordinator works with the patient using the system to direct this self-examination and record the results for the physician to review later as part of their visit with the patient. This allows various parties to use the system to assist the patient and arrive at the best possible outcome for the visit. At the end of the visit, the system allows any follow up scheduling, electronic prescriptions, referrals, etc to be performed by both parties (FIG. 1.80, 11) and creates a record of the visit that is archived and can be accessed by either party at a later time or sent to other providers, as needed for future visits.

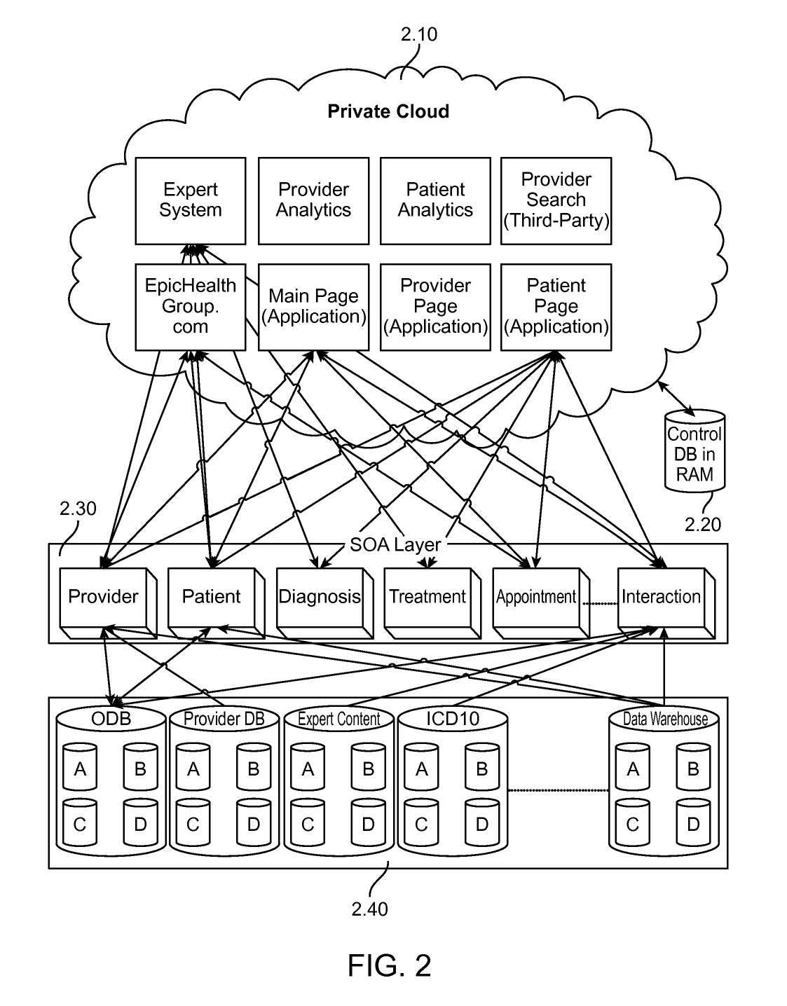

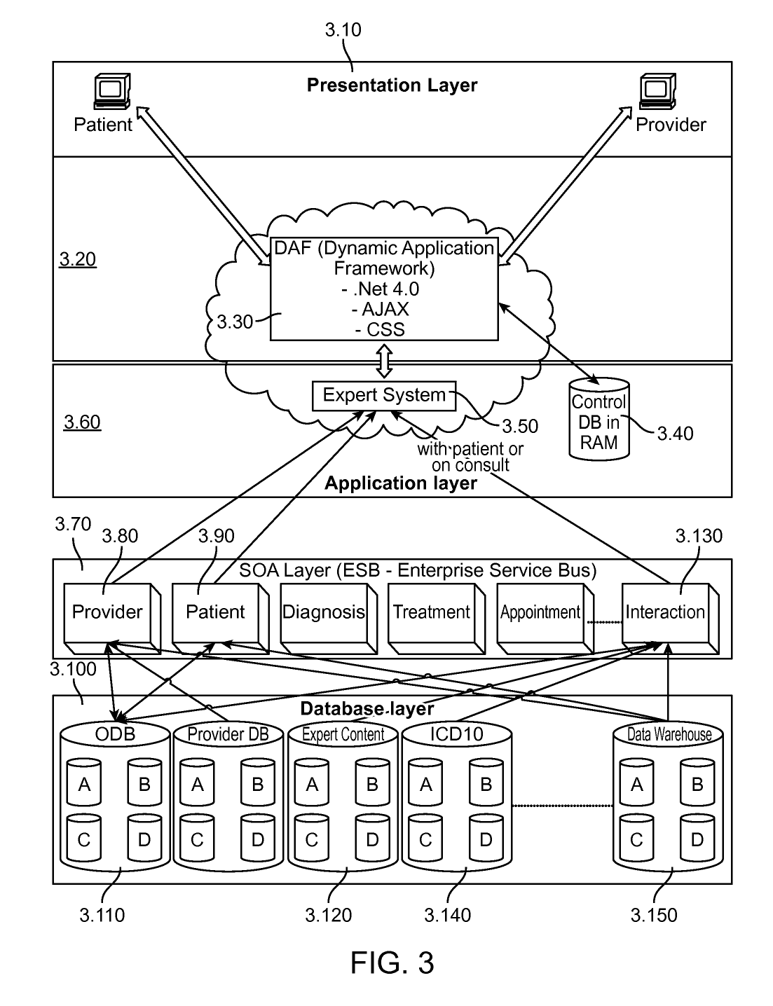

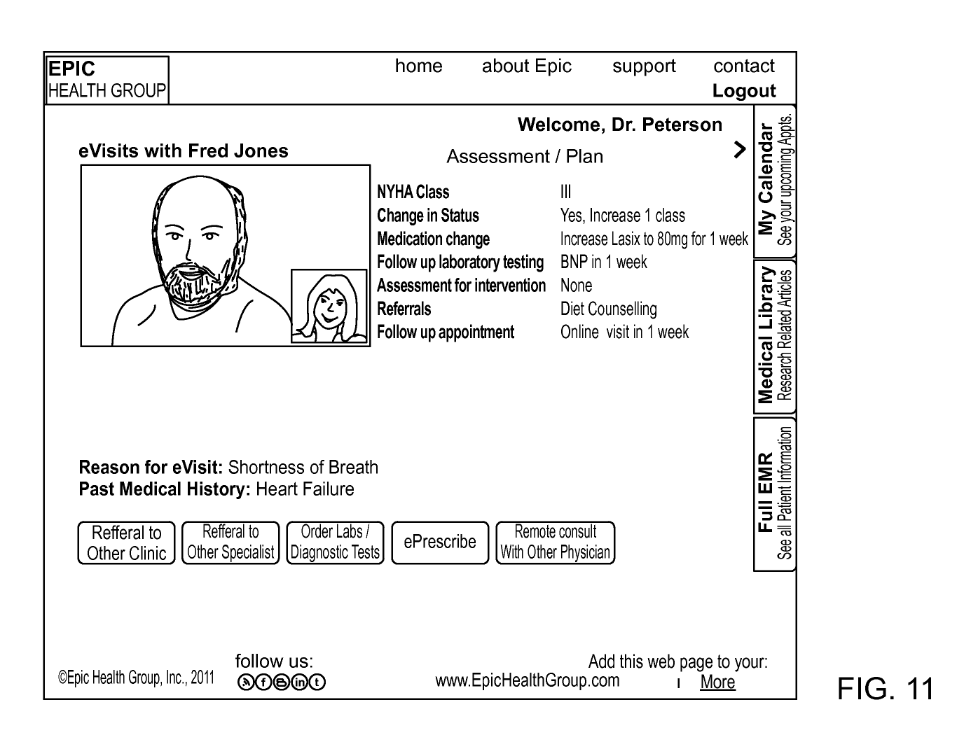

With reference to the drawings and, in particular, with reference to FIG. 2, the invention comprises a technology framework indicated generally as 2.10, 2.20, 2.30, and 2.40, which is the assembly of the underlying application components used to deliver the integrated solution that supports the system. These components preferably use current Microsoft technologies, including .Net, C#, IIS, CSS, and SQL/Server, along with the design standard of Ajax. Although described as using specific programming technologies, other technologies hereto developed or hereafter can be used without deviation from the scope of the invention as appreciated by one skilled in the art. In addition, third-party software including a SOA/ESB component are used to facilitate scalability both vertically and horizontally, allowing an increase in functionality as well as numbers of users. The System may include a rules based engine which may be deployed in the SOA layer of the system as indicated as 3.70 in FIG. 3 for the system component 3.50 in FIG. 3. This brings together the past medical history of the patient 3.100, allows for entry of current symptoms and conditions (FIG. 5,6), and leverages the rules engine 3.70 to activate the appropriate content (FIG. 3, 3.120, FIG. 5-8) and care pathway (FIG. 11) for the interaction (FIG. 7, 9-13) between the patient and the provider. This ensures appropriate guidance of the patient to prepare the right information for the physician, and the physician to be able to explore the key topics with the patient during their remote visit.

Upon login to the system, using the user's own system (FIG. 3, 3.10) consisting of a user device, such as a laptop, desktop computer, notebook, netbook, mobile device, etc., and being authenticated by a proprietary Control database (FIG. 3, 3.40) through a Secure Socket Layer (SSL), using a minimum of 256-bit encryption, the user gains access to the system, of which the system 3.50 is the key component. One skilled in the art will recognize that the computer systems may as a matter of design choice include any number and configurations of computers and databases, which may be used separately or in tandem to support the traffic and processing needs necessary in operation at one time. If multiple computers are used, the computer may be configured using a round-robin or load-balancing configuration to handle end user traffic.

Although not depicted in the figures, the one or more computers of computer system generally can include such art recognized components as are ordinarily found in such computer systems, including but not limited to processors, RAM, ROM, clocks, hardware drivers, associated storage, and the like. References herein to the term “database” or “database system” generally refers to one or more storage devices or computers with storage media storing a collection of records or data, as well as software for managing such records or data (commonly known as a database management system (or DBMS)). The database may take the form of a relational, hierarchical, network, or other known structure as may be deemed to be most efficient for the purposes of storing data or delivering the data used by the system. In a preferred embodiment, the present invention employs a relational database to store and deliver the various associations of data described herein.

Furthermore, each of the computer systems described herein preferably includes a network connection (not shown). The network connection may be a gateway interface to the Internet or any other communications network through which the systems can communicate with other systems and user devices. Network connection may connect to the communications network through use of a conventional modem (at any known or later developed baud rate), an open line connection (e.g., digital subscriber lines or cable connections), satellite receivers/transmitters, wireless communication receivers/transmitters, wired connection (Local Area Network).

The system 3.50 uses the Expert Content (FIG. 3, 3.120) through the SOA/ESB layer (FIG. 3, 3.70) to guide the provider and the patient through a series of screens (FIG. 5-13) that mix information gathering, guiding, alerts, etc. to arrive at the best possible outcomes. This content is specific to the patient complaint and history, as entered (FIG. 1, 1.10). The system software, in the current embodiment, uses a collection of web services developed specifically for this purpose to identify which content is appropriate for that particular interaction. For example, if a patient logs into the system with a complaint of shortness of breath and has a history of heart failure, as entered on screens (FIG. 5, 6), the Heart Failure Remote Care Pathway is initiated (FIG. 1, 1.30), which leverages the users input (FIG. 1, 1.10), prior history (FIG. 2, 2.40), and the expert content (FIG. 3, 3.120). This Pathway is customized to collect key pieces of information that a provider needs to know to determine if the patient is having an acute episode of heart failure, and is facilitated by physician/patient interaction (FIG. 7, 9-13). As will be understood to one skilled it the art, the operation and functionality of the embodiments described herein is provided, in part, by the server and user interface/display device. While the operation of these components is not described by way of particular code listings, it is to be understood that one skilled in the art will be able to arrive at suitable implementations based on the functional and operational details provided herein. Furthermore, the scope of the present invention is not to be construed as limited to any particular code or logic implementation. Additionally, the invention is not limited by any particular hardware or software implementation but rather can be implemented using known and hereafter computer technologies.

In one example, the process includes guiding both the provider and patient through remote interactive exercises (FIG. 7) that aim to uncover clues as to whether the patient has fluid retention and increasing weakness of the heart for instance. Also, the software compares the patient's treatment for heart failure with recommended guidelines and additional, detailed best practices, and identifies deficiencies and care gaps that can affect the clinical outcomes (FIG. 3, 3.50, 3.130, 3.110, 3.120, 3.130, 3.150). For example, if a patient with NYHA Class II heart failure is not treated with beta blockers, but guidelines, as defined in Expert Content 3.120, including the online physician (FIG. 1, 1.60) see that as a critical piece of treatment that is indicated to achieve the best possible outcomes is missing, the software can generate a reminder notice for the provider. Such notice can be in the form of a pop-up window (FIG. 1, 1.90, 12) or other notification technology. The physician may determine that beta blocker treatment can improve the patient's heart failure program, or decide that due to the patient's asthma, beta blockers may not be the right choice in this case (FIG. 1, 1.60, 12). The end result of this is the improved quality of the interaction between a provider and the patient (FIG. 1, 1.50).

With respect to the overall architecture, and specifically describing the architecture shown in FIG. 3, the system is designed in an n-tier architecture that can be scaled both vertically and horizontally, which allows for growth in both functionality (vertically) and size (horizontally). In the shown embodiment, there are five layers of architecture that make up the technical architecture, although more or fewer layers can be used depending on the size or scalability requirements. These are; User, Presentation, Application, SOA/ESB, and Database. Each layer leverages SSL and at least 256-bit encryption to securely deliver content outside the physical environment, and protect sensitive data, although other security technology features can be used.

User (3.10): This layer is supplied by the users of the system, and are comprised of the physical hardware (laptop, desktop, netbook, PDA/Mobile device), the underlying operating system, related software and a web browser (IE, FireFox, Safari, Chrome, etc.).

Presentation (3.20): The presentation layer consists of software written by third parties, which renders internal designs, graphics, and html. Preferably CS S, .Net, and Ajax are leveraged to deliver rich content in a highly configurable, RESTful and flexible manner to all users of the system although other programming techniques can be used as well. This layer also leverages the Control DB to determine user security, deliver presentation style, and enhance performance.

Application (3.60): In the application layer, all of the complex program logic, such as pattern matching, calculations, complex decision logic, and navigation support are handled. This is the layer that preferably contains all of the third-party applications. Additionally, ancillary program logic can be contained here, such as calendaring functionality, video conferencing, live chat, and integration points with trading partners.

SOA/ESB (3.70): The SOA/ESB layer contains the logic to bridge the gap between the application layer and the database layer. This is where the rules engine logic is preferably created using web services, which is at the heart of the system. This is accomplished by facilitating the movement, and when needed, the transformation of data. By using basic logic, the SOA/ESB layer defines an object, and then abstracts the complexities behind building that object from independent data sources within the database layer. For example, a Patient object is made up of data from several different data sources, and is brought together by the SOA/ESB layer into one coherent object containing all of this data, that is made available to any application needing to use “Patient” data. This facilitates the ability to make modifications to either the application or the database without affecting the other.

Database (3.100): The database layer is a collection on tables, views, indexes, and stored procedures preferably containing substantially all of the data necessary to operate the system. In this embodiment, all internal data is contained in a MS SQL/Server database, and external data is contained in a database, or data source, compatible with the SOA/ESB layer (MS SQL/Server, Oracle, DB2, CSV, XML, Access, Teradata, etc.), although other technologies can be utilized in addition to or instead of those listed above.

As shown in FIG. 3, the system may include diagnosis and disease specific modules (FIG. 3, 3.60) and content (FIG. 3, 3.120) to assist providers and patients achieve the best possible clinical outcomes in their remote interactions. These modules may include information regarding the medical specialties, including Allergy/Immunology, Gastroenterology, Dermatology, Cardiology, Pulmonology, Endocrinology, Hematology/Oncology, Infectious Disease, Nephrology, Rheumatology, Neurology, Orthopedics, Ophthalmology, Pediatrics, Otolaryngology, Psychiatry and other areas.

As shown in FIG. 5, a patient with a new cough may log into the system (FIG. 5) with symptoms of new cough and no previous history of cough or other related diagnosis, activating the content (FIG. 3, 3.120) that is relevant for evaluation of new cough and its potential causes. The system may request the patient to input historical information (a history) or relevant information including the patient's history of smoking, heartburn, exercise-induced cough, exposure to cold or other allergens, new environment or climate, and other relevant data that the provider needs to direct the work up. As shown in FIG. 7, the remote examination (FIG. 7) may collect additional patient information such as aggravation of cough with postural changes, change in the color of nail beds, color of sputum, reverberation sensation over the chest with exhalation, lower extremity swelling, etc. The rules engine may analyze this information, and based on the results the provider can then present a treatment plan (FIG. 1, 1.160), which can include chest X-ray, laboratory work, trial medications, and office follow up for full examination and review of the diagnostic results (FIG. 11). This results in the most efficient evaluation and care in the lowest possible cost settings for the various stages of the work-up and by appropriate providers.

Alternatively, in another example of the performance of systems in accordance with the invention, if the patient inputs information indicating increased fatigue and low energy level with a history of depressed mood, this will activate content/modules that probe organic causes of the patient's symptoms as well as potential recurrent depression. The system may dynamically determine follow up questions to present to the patient, wherein the patient may input information related to illnesses such as upper respiratory infection, recent change in skin color and tone, cognitive changes, constipation, excessive sleepiness, recent traumatic events such as loss of loved ones, relationship issues, etc. A remote examination (FIG. 7) may include temperature, tenderness upon percussion over the sinuses or pulling of the ear, feeling of nodules or tenderness over the thyroid gland, pulse, reflexes, etc. The provider can run through a depression assessment, including a potential remote consultation with a specialist (FIG. 11) and the patient and schedule laboratory tests to rule out certain conditions that might be responsible for the patient's fatigue and lower energy levels. The System allows a physician extender to perform a significant part of the assessment and involve the physician at the appropriate point of the remote evaluation. This allows all providers to provide maximum value and be as efficient as possible.

The System may include an audio, video and/or Internet communication channel (FIG. 7, 9-13), or the System may utilize other forms of technology enabled interactions such as over a local area network (“LAN”) or wide area network (“WAN”). Also, although certain data can be acquired using remote monitoring devices or visual inspection using web cameras (FIG. 1, 1.50 and FIG. 7, 10) many of the critical pieces of information are not readily apparent or available. Also, only a minority of patients have remote monitoring devices used in their care. The system may also include medical measuring devices such as thermometers, blood pressure cuffs or other devices which enhance the providers ability to remotely monitor the patient.

The system is meant to help providers and patients to collaborate in getting critical pieces of information needed for diagnosis (FIG. 1, 1.50 and FIG. 5-13). A provider directed, patient-performed examination uses innovative approaches to have the patient perform maneuvers (FIG. 7) and report their effects (FIG. 7) so that the provider can gain the key clues needed to determine the underlying condition responsible for the patient's complaints, and allow for the most effective treatment possible (FIG. 11). The remote interactions using the System have a higher chance of success as a result of this proprietary knowledge base (FIG. 3, 3.120) and the short-term and long-term outcomes are improved. This results in higher efficiency and a lower chance of follow up visits to a medical facility. This also results in lower overall cost of care as chances of correct diagnosis and treatment (FIG. 1, 1.60) with the initial visit is improved and the potential of needing institutional care is lowered.

While the foregoing description and drawings represent the preferred embodiments of the present invention, it will be understood that various additions, modifications, combinations and/or substitutions may be made therein without departing from the spirit and scope of the present invention as defined. In particular, it will be clear to those skilled in the art that the present invention may be embodied in other specific forms, structures, arrangements, proportions, and with other elements, materials, and components, without departing from the spirit or essential characteristics thereof. One skilled in the art will appreciate that the invention may be used with many modifications of structure, arrangement, proportions, materials, and components and otherwise, used in the practice of the invention, which are particularly adapted to specific environments and operative requirements without departing from the principles of the present invention. In addition, features described herein may be used singularly or in combination with other features. The presently disclosed embodiments are therefore to be considered in all respects as illustrative and not restrictive, the scope of the invention being indicated by the appended claims. Moreover, the scope of the present invention covers conventionally known or future developed variations and modifications to the components described herein, as would be appreciated by one of ordinary skill in the art.

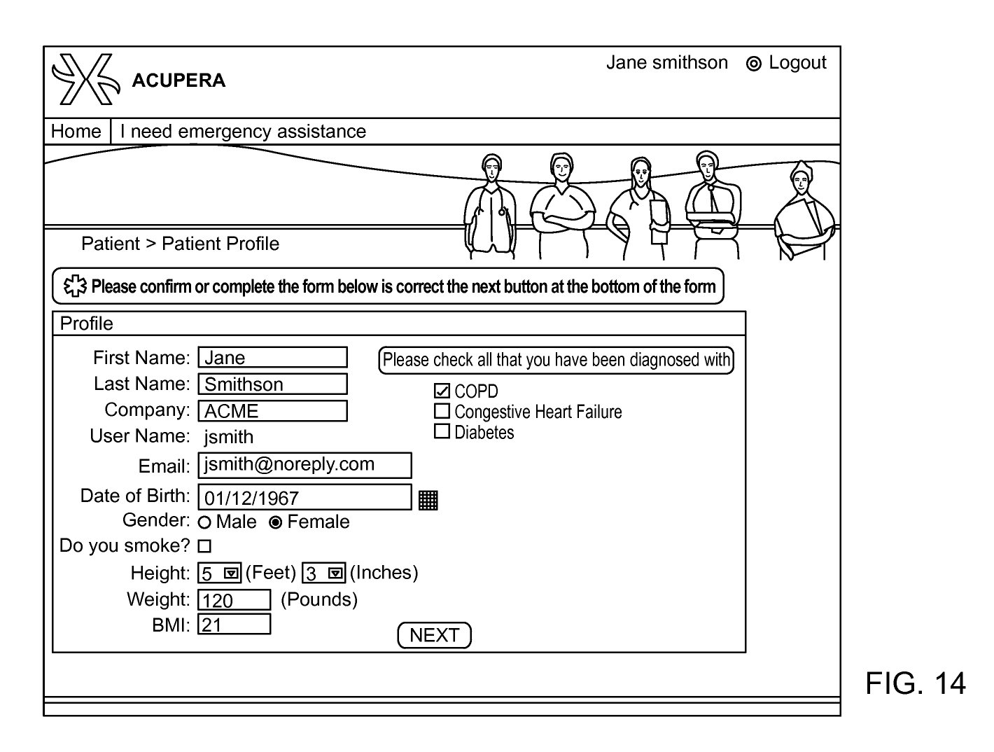

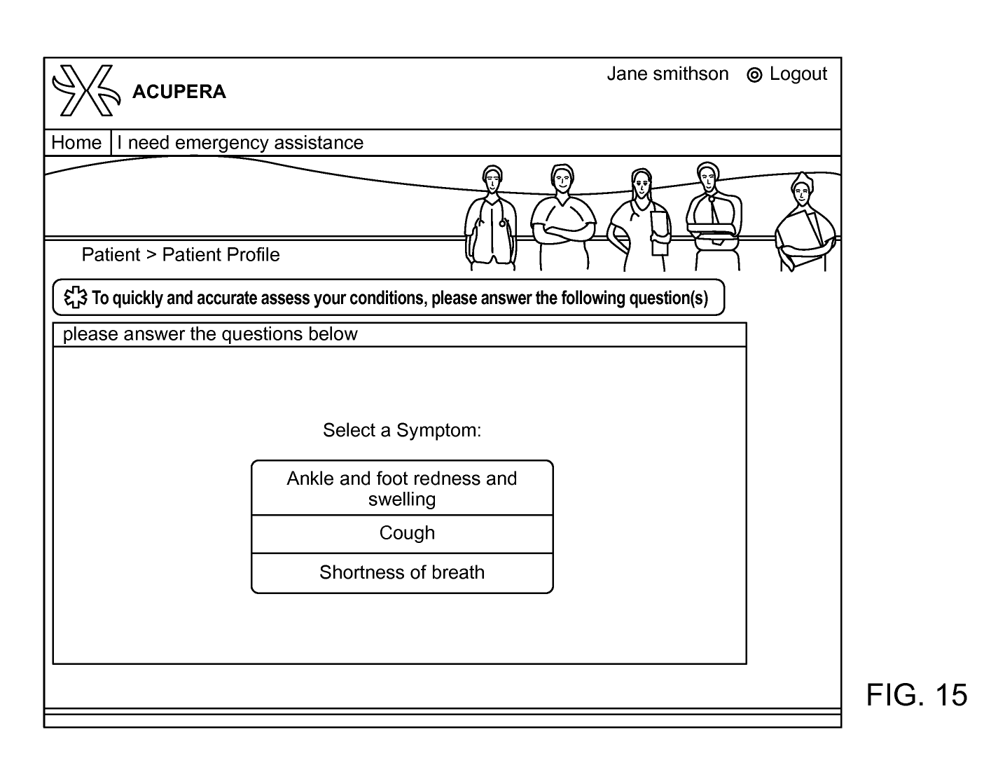

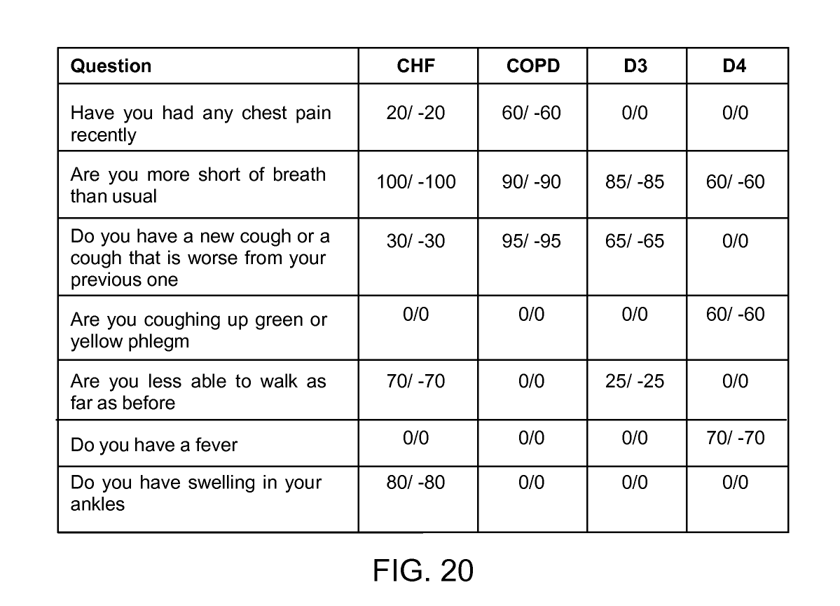

FIGS. 19 and 20 detail the processor/logic engine method of determining the probable diagnosis for a patient presenting symptom. The aforementioned system architecture coordinates the transfer and presentation of relevant information. For instance the user would log into the system via applications in the presentation layer. The Expert System 3.50 logic engine handles the extraction of relevant expert content via the SOA layer, which intern accesses databases containing relevant disease information and EMRs if available. If the patient's relevant medical history is available the processor/logic engine will calculate a matrix of probable diagnoses (PD) such as CHF, COPD, or other diagnoses D3-Dn in a table containing relevant diagnostic questions derived from the expert content. An example of such a matrix is shown in FIG. 14. Each diagnostic question change has the ability to change the score or probability value (PV) of the PDs. For example an affirmative response to the question “Have you had any chest pain recently?” will elevate the PV for COPD by 20 points. A negative response to the same question will subtract 20 points from the PV of the COPD PD. Prior patient medical history is used not only to initially populate the matrix PV but may also assign multiplier values to the PV or apply multiplier values to the effect of the questions. For instance, if the patient is a smoker he/she will have an elevated risk of COPD and the initial PV for COPD may augmented by a factor of 1.2. Similarly, if the patient is a smoker, a symptom of shortness of breath may also be augmented by the PV modifier for that diagnosis by a multiplicative factor.

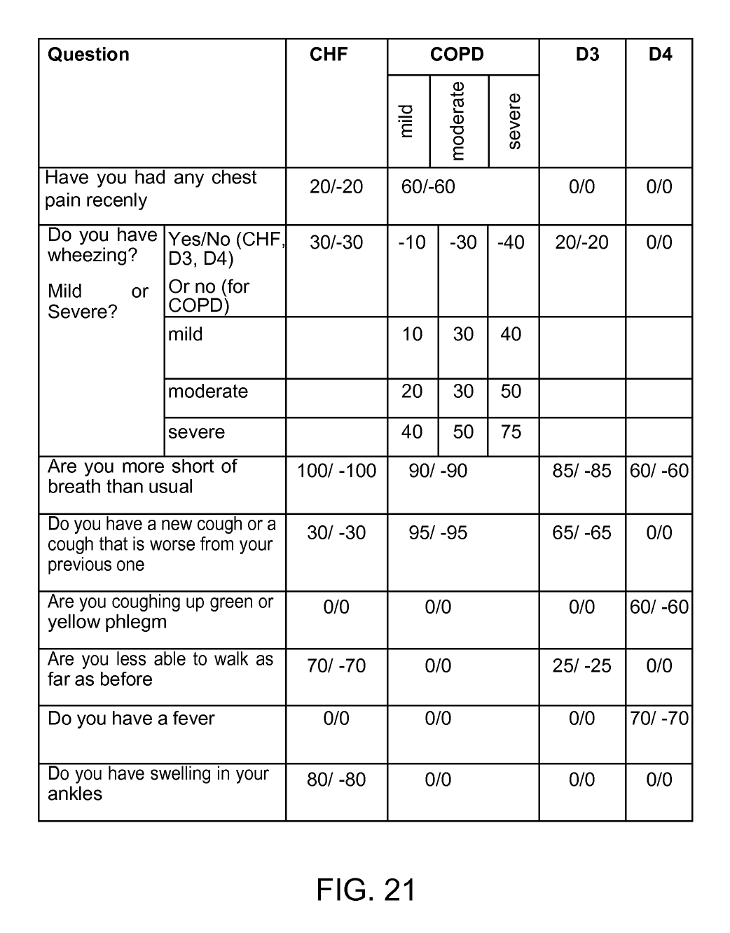

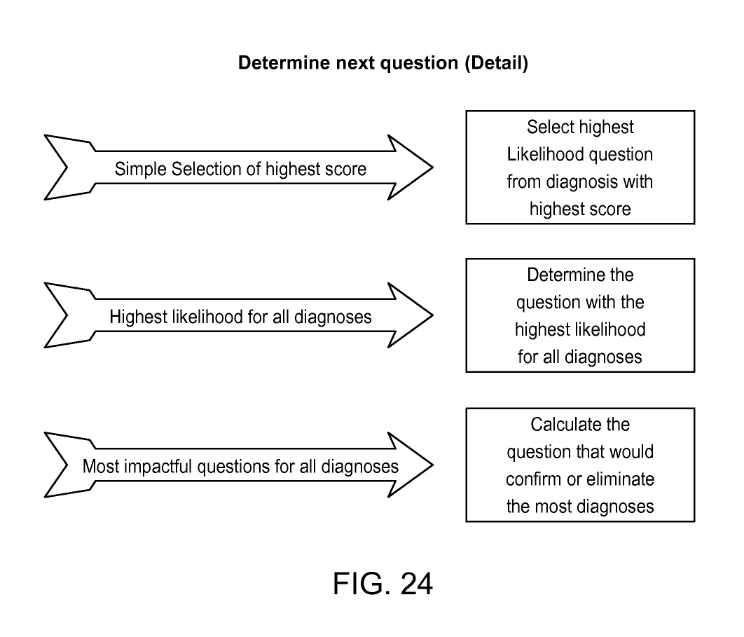

The system prompts the user with each question successively and after each question recalculates the PVs for each PD. After each question and recalculation of the PV-PD Matrix the system checks to see if the diagnostic threshold is crossed. If the PV for a particular PD is above the diagnostic threshold that PD is selected as the most likely diagnosis. If the diagnostic threshold has yet to be crossed then questioning continues. Should the system exhaust the number of questions available for a given disease module provided by the expert content then the system may make an appointment for the patient by accessing the patient appointment functionalities of the application layer 3.7 and database layer 3.100, through the SOA layer 3.7. FIG. 20 shows a variation of the above described diagnostic logic engine wherein the severity of symptoms and conditions can be taken into account. For instance the severity of wheezing may correlate with the severity of COPD. A different probability is independently assigned for the severity of wheezing as it relates to having mild, moderate, or severe COPD. In this instance having sever COPD is also treated as having mild and moderate COPD. The expert content may generate separate probability scores for each combination of staged (PD) and presenting symptom. The aforementioned yes/no probability calculations are used for CHF, D3, and D4 but separate tracking of graded symptoms is used for COPD. This illustrates that multiple disease specific calculations can be used within the same logic engine. FIG. 21 shows a variation of the above described diagnostic logic engine wherein the severity of symptoms and conditions can be taken into account. For instance the severity of wheezing my correlate with the severity of COPD. A different probability is independently assigned for the severity of wheezing it relates to having mild, moderate, or severe COPD. In this instance having sever COPD is also treated as having mild and moderate COPD. The expert content may generate separate probability scores for each combination of staged (PD) and presenting symptom. The aforementioned yes/no probability calculations are used for CHF, D3, and D4 but separate tracking of graded symptoms is used for COPD. This illustrates that multiple disease specific calculations can be used within the same logic engine. FIG. 24 details different logic engine methods for choosing the next question to be asked during this process. Questions may be chosen on the basis of what would most likely provide a diagnosis of the currently highest scored PD. Alternatively the next question may be that which would produce the highest likelihood for all diagnosis or a question that would confirm or eliminate most available PDs.

The logic engine/processor, described above, used to determine a diagnosis may also use the additional feature of condition and symptom staging. FIG. 21 shows the staging of a COPD and a corresponding symptom of wheezing. In this embodiment COPD is described as either being mild, moderate, or severe. Likewise the symptom of wheezing is described as absent, mild, moderate or severe.

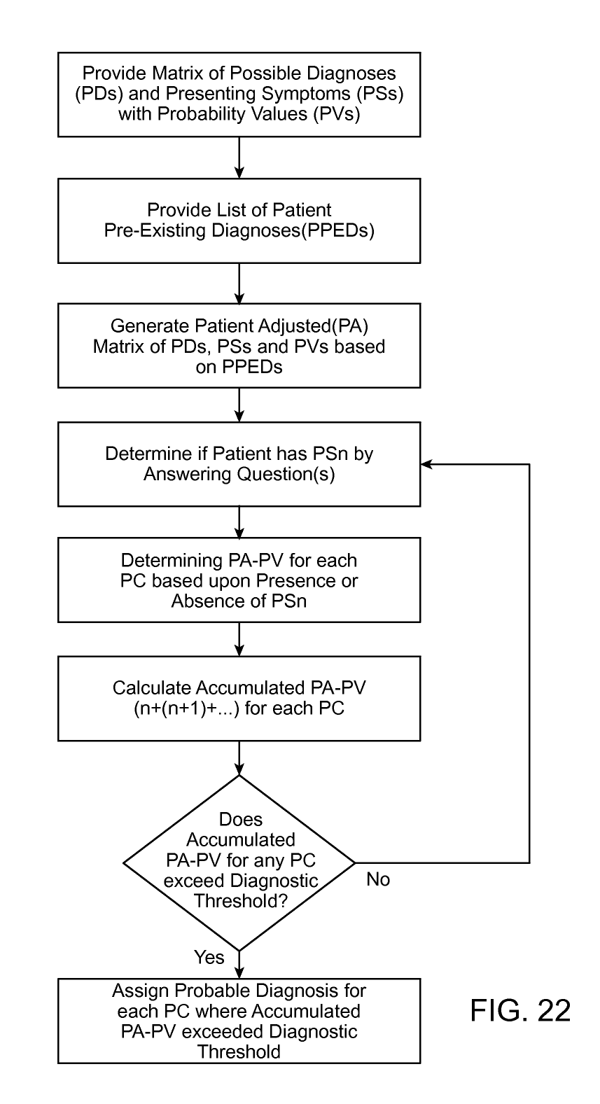

FIG. 22 shows a flow diagram for the logic engine/processor used to determine the most likely diagnosis for a patient. The system generates a matrix of Possible Diagnoses (PDs) and Presenting Symptoms (PSs) with Probability Values (PVs) as shown in FIGS. 20 and 21. The patient's medical history and risk factors including Patient Pre-existing Diagnoses (PPEDs) are used to create a Patient Adjusted (PA) Matrix of PDs, PSs and PVs based on the patient specific medical information gathered by the system. The System then asks the patient a question to determine if the patient has a given PS(n). the PA-PV matrix is updated based on the finding of PS(n). If a non of the PD's PV scores exceed a the system diagnostic threshold then the system asks a question to determine if the patient has PS(n+1). The PA-PV matrix is again updated to take into account the patient's having or not having PS(n+1). If the diagnostic threshold is not exceeded still the system repeats this process for to PS (n+2) and so on and so forth. If one or more PVs for any PDs in the accumulated PA PV matrix (for n+(n+1)+n(n+2)+ . . . ) exceeds the diagnostic threshold after the last question then those PDs are assigned as the Probable Diagnoses.

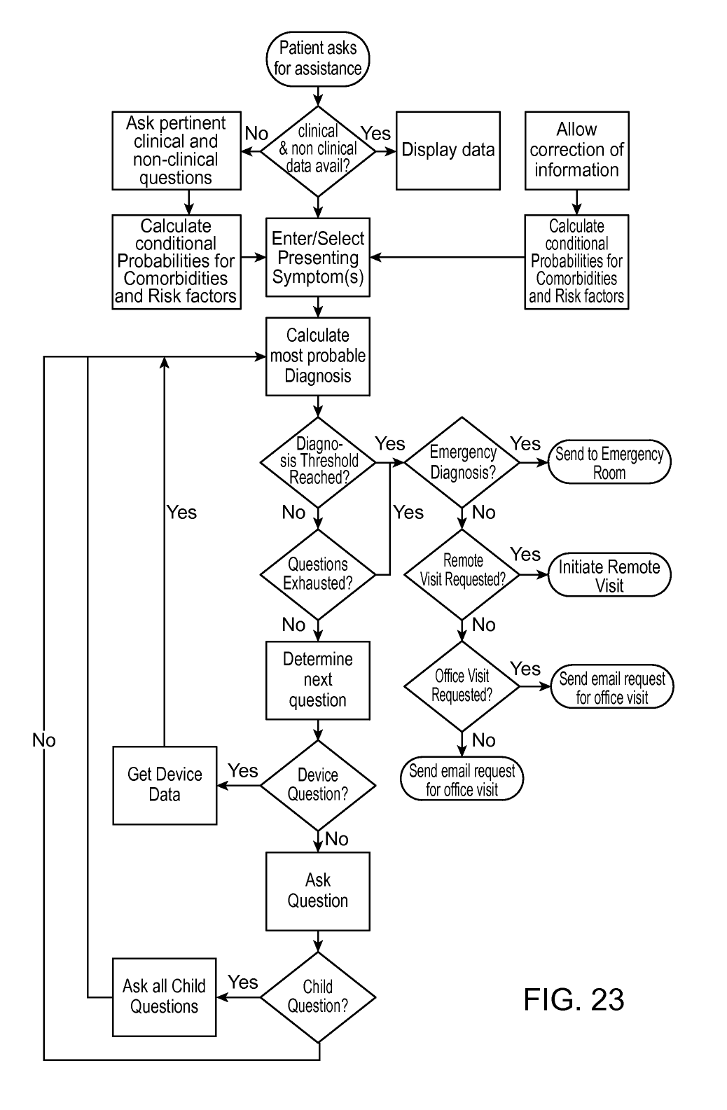

FIG. 23 shows a flow diagram of the patient/system interaction in a typical embodiment of the invention. The patient logs in and asks for assistance. The system coordinates the gathering of clinical and non-clinical data relevant to the patient. It can either display such data and offer an opportunity for correction or ask for relevant data if such data is missing. Conditional probabilities for co-morbidities and risk factors are calculated once such clinical and non-clinical data is finalized. At this point the patient enters his/her presenting symptoms through a screen or series of screens (FIG. 15-17). The logic engine/processor calculates a most probable diagnosis as describe above. Questions are asked until a diagnostic threshold has been reached or until the relevant questions have been exhausted. This flow diagram shows that some questions can be answered with data obtained by a periphery device used by the user or connected to the user's computer. Examples of such a device can be but are not limited to a heart rate monitor, blood pressure monitor, blood glucose sensor, and the like. Some questions will trigger child questions. Child questions are a question or set of questions which are automatically asked upon receipt of certain answers to known questions. For instance if the system asks the patient if he or she is experiencing chest pain the system will automatically ask the nature and severity of the chest pain to determine if a emergency myocardial infarction is taking place. If all relevant questions are exhausted the patient is referred to seek in person medical assistance. Once a diagnostic threshold is reached the system determines if an emergency situation is present if so the patient is directed an emergency room. If the diagnosis is a non-emergency situation a remote visit with a health care provider may be initiated or a office visit may be requested.

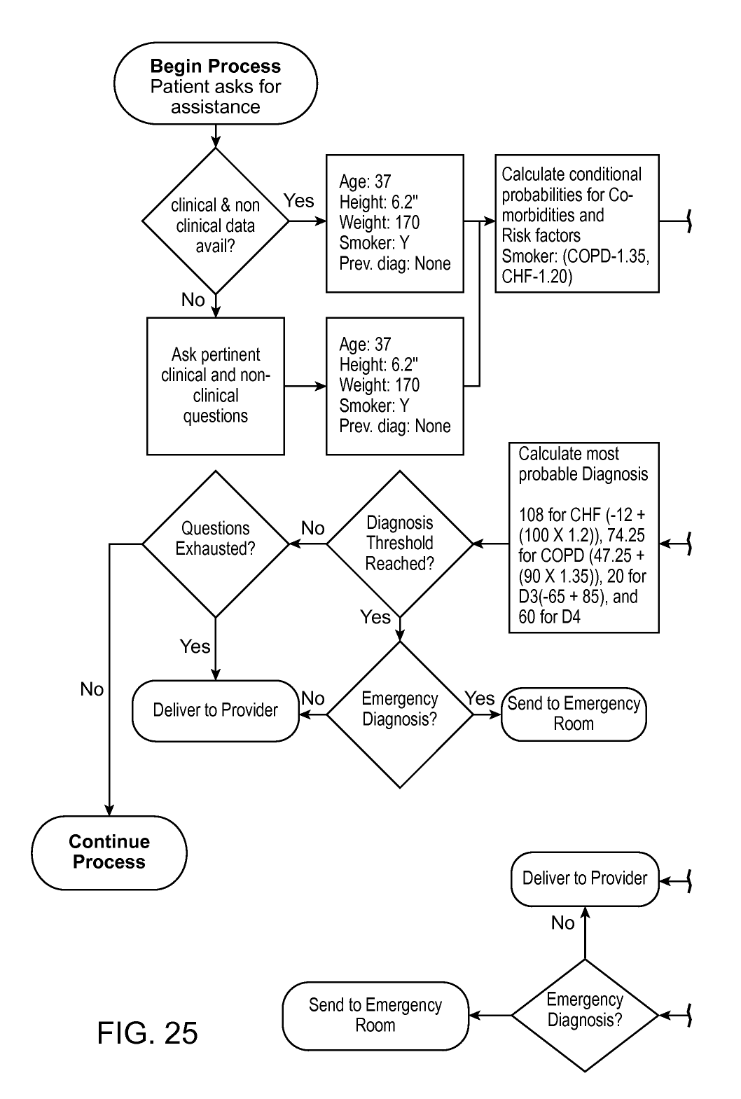

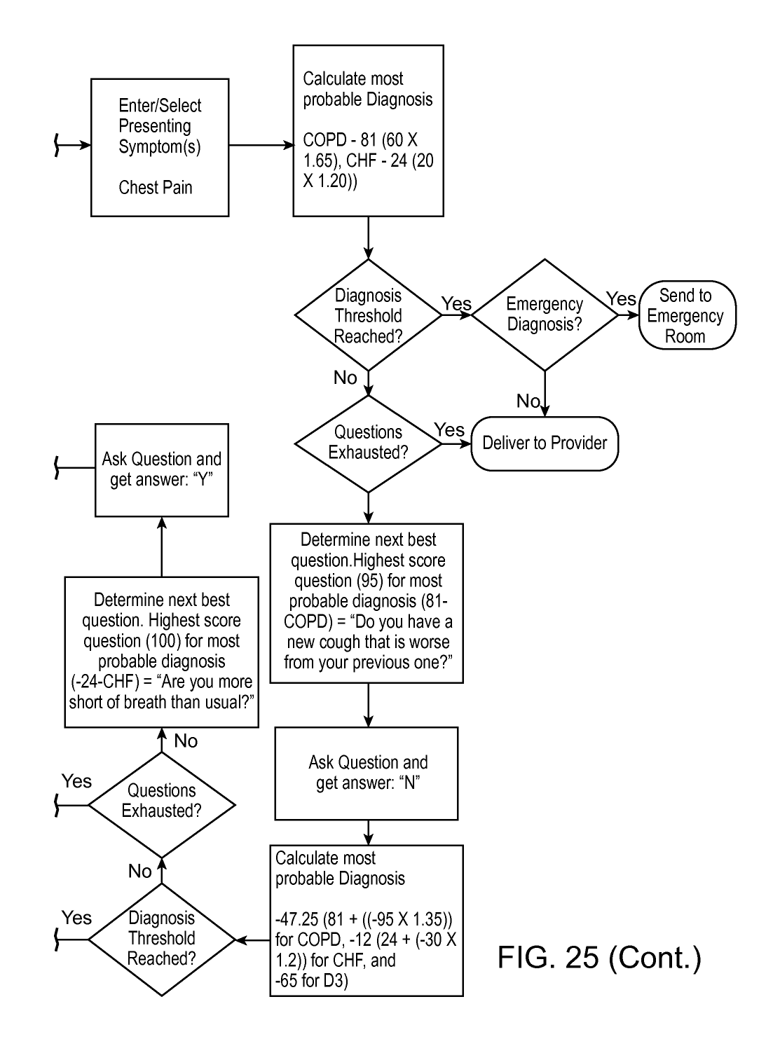

FIG. 25 shows a flow diagram of the patient/system interaction as describe above with a more explicit diagnostic calculus.

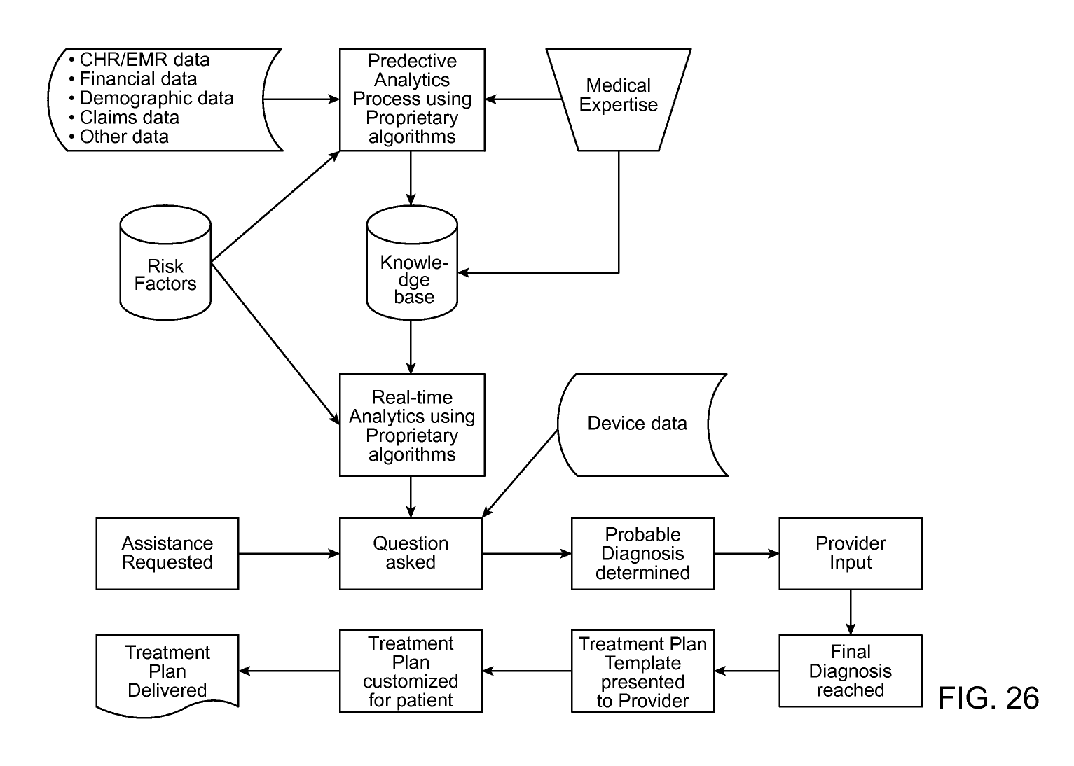

FIG. 26 shows a flow diagram detailing the diagnosis of a patient presenting symptoms and the subsequent treatment plan delivery. Various patient data (EHR, financial, demographic, claims, and other data) is applied to the predictive analytics of the present invention along with information contained in the medical expertise module and known patient risk factors. The data is processed through the knowledge base further taking into account medical expertise. Real time analytics is then applied with risk factors to the current data. The system then generates and asks questions from the user and may request device data. Through the questioning and methods described above a probable diagnosis is arrived. Medical provider input is then used to reach a final diagnosis and a treatment plan devised. The invention aids in provider customization of the treatment plan which is delivered to the patient.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method utilizing an interface and a processor for determining a probable diagnosis for a patient, said method comprising:
(a) providing to the processor a matrix of possible diagnoses and presenting symptoms, wherein each presenting symptom has an assigned conditional probability value for each possible diagnosis;
(b) providing to the processor a list of pre-existing diagnoses for the patient, wherein the processor generates a patient-adjusted matrix of possible diagnoses and presenting symptoms having patient-adjusted probability values based upon the patient's pre-existing conditions and risk factors;
(c) answering on the interface one or more questions to determine if the patient has a presenting and additional symptoms and device readings;
(d) determining the patient-adjusted probability value for each possible diagnosis based upon the presence or absence of the presenting symptom as determined in step (c);
(e) calculating an accumulated patient-adjusted probability value for each possible diagnosis by adding the value determined in step (d) to any previous values determined in step (d); and
(f) assigning a probable diagnosis to the patient if an accumulated patient-adjusted conditional probability value determined in step (e) exceeds a pre-determined diagnostic threshold value; or
(g) repeating steps (c) through (e) if no accumulated patient-adjusted probability value determined in step (e) exceeds a pre-determined threshold value or all questions have been exhausted.

2. A method as in claim 1, wherein the interface is selected from a group consisting of a tablet, a kiosk, a computer, a smart phone, and a telephone.

3. A method as in claim 1, wherein the processor comprises a central processor or a group of distributed processors.

4. A method as in claim 1, wherein the interface and processor are networked from remote locations.

5. A method as in claim 1, wherein the interface and the processor are located in an integral unit, wherein at least one of the matrix of possible conditions and presenting symptoms and the list of patient pre-existing conditions is maintained at a remote location.

6. A method as in claim 1, further comprising prioritizing the order of questions asked in step (c) based on the patient's pre-existing conditions.

7. A method as in claim 1, further comprising prioritizing the order of questions asked in step (c) based upon the probability values for each condition determined in step (d) when steps (c) through (e) are being repeated in accordance with step (g).

8. A method as in claim 1, wherein at least some of the questions are answerable with a yes or no.

9. A method as in claim 1, further comprising inputting presenting test data into the interface wherein step (d) relies on both the presenting symptoms and on the presenting test data to determine the patient-adjusted probability value for each condition.

10. A method as in claim 1, further comprising answering on the interface one or more additional questions to determine severity of a condition after a probable diagnosis has been assigned in step (f).

11. A method as in claim 1, wherein the diagnoses include at least some conditions selected from the group consisting of COPD, congestive heart failure (CHF), diabetes, asthma, depression, and hypertension.

12. A method as in claim 1, wherein the presenting symptoms include at least some symptoms selected from the group consisting of chest pain, trouble breathing, presence of a cough, green sputum, radiating arm pain, and fever.

13. A method as in claim 1, wherein the test data include at least some test data selected from blood pressure, heart rate, temperature, glucose level.

14. A system for determining a probable diagnosis for a patient, said system comprising:
a database providing a matrix of conditional probability values for each of a plurality of possible diagnoses based upon each of a multiplicity of presenting symptoms;
a database providing a list of pre-existing diagnoses for the patient;
an interface;
a processor which communicates with the interface and receives data from the matrix database and the list database, wherein the processor is configured to perform the following steps:
(a) generate a patient-adjusted matrix of patient-adjusted conditional probability values based upon the patient's pre-existing conditions and risk factors;
(b) generate and present question(s) on the interface, wherein answer(s) input on the interface determine if the patient has a symptom;
(c) determine the patient-adjusted probability value for each possible diagnosis based upon the presence or absence of each symptom;
(d) calculate an accumulated patient-adjusted probability value for each possible diagnosis by adding the value of all of the patient-adjusted conditional probability values that have been determined for that possible diagnosis; and
(e) assign a probable diagnosis to the patient when an accumulated patient-adjusted probability value exceeds a predetermined diagnostic threshold value; or
(f) repeat steps (b) through (d) if no accumulated patient-adjusted probability value exceeds a predetermined threshold and additional questions which have not been previously answered are available to ask the patient.

15. A system as in claim 14, wherein the interface is selected from a group consisting of a tablet, a kiosk, a computer, a smart phone, and a telephone.

16. A system as in claim 14, wherein the processor comprises a central processor or a group of distributed processors.

17. A system as in claim 14, wherein the interface and processor are networked from remote locations.

18. A system as in claim 14, wherein the interface and the processor are located in an integral unit, wherein at least one of the matrix of possible diagnoses and symptoms and the list of patient pre-existing conditions and risk factors are maintained at a remote location.

19. A system as in claim 14, wherein the processor is further configured to prioritize the questions asked in step (c) based on the patient's pre-existing diagnoses and risk factors.

20. A system as in claim 14, wherein the processor is further configured to prioritize the questions asked in step (c) based upon the conditional probability values for each diagnosis determined in step (d) when steps (c) through (e) are being repeated in accordance with step (g).

21. A system as in claim 14, wherein the processor is further configured to input presenting test data into the interface wherein step (c) relies on both the symptoms and on the presenting test data to determine the patient-adjusted conditional probability value for each possible diagnosis.

22. A system as in claim 14, wherein at least some of the questions are answerable with a yes or no.

23. A system as in claim 14, wherein the processor is further configured to answer on the interface one or more additional questions to determine severity of a condition after a probable diagnosis has been assigned in step (f).

24. A system as in claim 14, wherein the diagnoses include at least some conditions selected from the group consisting of COPD, congestive heart failure (DHF), diabetes, asthma, depression, hypertension.

25. A system as in claim 14, wherein the presenting symptoms include at least some symptoms selected from the group consisting of chest pain, trouble breathing, presence of a cough, green sputum, radiating arm pain, fever.

26. A system as in claim 14, wherein the test data include at least some test data selected from blood pressure, heart rate, temperature, glucose level.
